(19) United States
(12) Patent Application Publication
(10) Pub. No.: US 2024/0365176 A1
(43) Pub. Date: Oct. 31, 2024

(54) METHODS EXECUTED BY FIRST NODE AND SECOND NODE, AND RELATED DEVICES

(71) Applicant: Samsung Electronics Co., Ltd., Suwon-si (KR)

(72) Inventors: Xi SONG, Beijing (CN); Jiajia WANG, Beijing (CN); Haiyi LIU, Beijing (CN); Hongli LU, Beijing (CN); Wei LI, Beijing (CN); Azhen PENG, Beijing (CN)

(21) Appl. No.: 18/670,019

(22) Filed: May 21, 2024

Related U.S. Application Data
(63) Continuation of application No. PCT/KR2024/004984, filed on Apr. 12, 2024.

(30) Foreign Application Priority Data
Apr. 17, 2023 (CN) 202310409550.8
Jun. 6, 2023 (CN) 202310667362.5
Jan. 10, 2024 (CN) 202410039453.9

(51) Int. Cl. H04W 28/26; H04W 28/02; H04W 28/20

(52) U.S. Cl. CPC H04W 28/26; H04W 28/0278; H04W 28/20

(57) ABSTRACT

A method performed by a first node is provided. The method includes acquiring traffic-related information of user equipment (UE), determining, based on the traffic-related information, at least one UE group, determining, for each of the at least one UE group, corresponding reserved resource information, and transmitting, to a second node, the reserved resource information corresponding to each of the at least one UE group, wherein traffic of each UE in the at least one UE group is processed based on the reserved resource information.

### CROSS-REFERENCE TO RELATED APPLICATION(S)

This application is a continuation application, claiming priority under § 365 (c), of an International application No. PCT/KR2024/004984, filed on Apr. 12, 2024, which is based on and claims the benefit of a Chinese patent application number 202310409550.8, filed on Apr. 17, 2023, in the Chinese Intellectual Property Office, of a Chinese patent application number 202310667362.5, filed on Jun. 6, 2023, and of a Chinese patent application number 202410039453.9, filed on Jan. 10, 2024, in the Chinese Intellectual Property Office, the disclosure of each of which is incorporated by reference herein in its entirety.

### TECHNICAL FIELD

The disclosure relates to the technical field of wireless communications and artificial intelligence. More particularly the disclosure relates to methods executed by a first node and a second node, and related devices.

### BACKGROUND

Ultra-reliable and low-latency communication (URLLC) is one of the three major visions of fifth generation (5G). In a research case of 3rd Generation Partnership Project (3GPP), the stringent latency requirement can reach up to 1 ms. In order to guarantee the stringent latency requirement and high reliability, 3GPP working team proposed a series of new technical solutions, such as uplink grant-free scheduling and 5G network slicing.

Low latency guaranteeing for traffic with a high latency demand is one of the important technical directions in current researches.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods executed by a first node and a second node, and related devices.

Additional aspects will be set forth in part in the description which follows and, in part, will be apparent from the description, or may be learned by practice of the presented embodiments.

In accordance with an aspect of the disclosure a method performed by a first node in a wireless communication system is provided. The method includes acquiring traffic-related information of user equipment (UE), determining, based on the traffic-related information, at least one UE group, determining, for each of the at least one UE group, corresponding reserved resource information, and transmitting, to a second node, the reserved resource information corresponding to each of the at least one UE group, wherein traffic of each UE in the at least one UE group is processed based on the reserved resource information.

In a feasible embodiment, the traffic-related information includes at least one of delay-related information and period-related information.

In a feasible embodiment, the determining, for each the at least one UE group, of the corresponding reserved resource information includes determining, for a same UE group of different network slices, the corresponding reserved resource information, or determining, for a same UE group of a same network slice, the corresponding reserved resource information.

In a feasible embodiment, the determining, based on the traffic-related information, of the at least one UE group includes partitioning, based on the traffic-related information, UEs corresponding to a first traffic type into at least one UE group.

In a feasible embodiment, the first traffic type includes a traffic type for which a delay requirement for traffic is not greater than a preset first delay threshold value.

In a feasible embodiment, the UE group includes at least one of a first UE group for which a delay requirement for traffic is not greater than a preset second delay threshold value and the traffic is periodic traffic, a second UE group for which a delay requirement for traffic is not greater than the preset second delay threshold value and the traffic is aperiodic traffic, a third UE group for which a delay requirement for traffic is greater than the preset second delay threshold value and the traffic is the periodic traffic, or a fourth UE group for which a delay requirement for traffic is greater than the preset second delay threshold value and the traffic is the aperiodic traffic.

In a feasible embodiment, the determining, for each UE group, of the corresponding reserved resource information includes at least one of for the first UE group and/or the second UE group, determining, based on resource information required for performing traffic data transmission, the reserved resource information, or determining, for the third UE group and/or the fourth UE group, based on resource information required for resource scheduling, the reserved resource information.

In a feasible embodiment, the resource information required for resource scheduling includes resource information corresponding to a scheduling request (SR) and/or a buffer status report (BSR).

In a feasible embodiment, the determining, for each of the at least one UE group, of the corresponding reserved resource information includes at least one of determining, for the periodic traffic included in the first UE group and/or the third UE group, based on a traffic transmission period, a first period, determining, based on the delay requirement for traffic, a second period, and determining, based on each of the first period and the second period, the reserved resource information, or determining, based on the delay requirements for the second UE group and/or the fourth UE group, a third period, and determining, based on the third period, the reserved resource information.

In a feasible embodiment, determining, for each of the at least one UE group, of the corresponding reserved resource information includes executing, for each of the at least one UE group, at least one of the following operations determining, based on a level of multiplexing in time domain, a level of multiplexing in frequency domain and/or a level of multiplexing in space domain, at least one UE set corresponding to the UE group, and determining the reserved resource information for each of the UE sets to process, based on the reserved resource information, traffic of each UE in a corresponding UE set, or determining, based on a simultaneous transmission probability and/or interference information between the UEs, at least one UE set corresponding to the UE group, and determining the reserved resource information for each UE set to process, based on the reserved resource information, traffic of each UE in a corresponding UE set.

In a feasible embodiment, the determining, based on the level of multiplexing in the time domain, the level of multiplexing in the frequency domain and/or the level of multiplexing in the space domain, the at least one UE set corresponding to the UE group, and the determining of the reserved resource information for each of the UE sets include determining, based on the level of multiplexing in the time domain, the level of multiplexing in the frequency domain and/or the level of multiplexing in the space domain, candidate UE sets corresponding to the UE group, determining first spectral efficiency corresponding to each candidate UE set, determining, based on the first spectral efficiency, at least one UE set from the candidate UE sets, and determining the reserved resource information corresponding to each UE set.

In a feasible embodiment, the determining, based on a simultaneous transmission probability and/or interference information between the UEs, of the at least one UE set corresponding to the UE group includes determining a simultaneous transmission probability of at least two UEs in the UE group, determining interference information between the at least two UEs in the UE group, determining, based on the simultaneous transmission probability and/or the interference information, a probabilistic multiplexing gain of the at least two UEs in the UE group, where the probabilistic multiplexing gain indicates an increased data transmission rate after the at least two UEs perform, based on the simultaneous transmission probability, resource multiplexing, and determining, based on the probabilistic multiplexing gain, at least one UE set corresponding to the UE group.

In a feasible embodiment, the determining of a simultaneous transmission probability of at least two UEs in the UE group includes determining, for the at least two UEs in the UE group, based on predicted traffic distribution, the simultaneous transmission probability of the at least two UEs on each slot.

In a feasible embodiment, the determining, based on predicted traffic distribution, of the simultaneous transmission probability of the at least two UEs includes one of predicting first traffic distribution of periodic traffic, and determining, based on the first traffic distribution, a first transmission probability of the at least two UEs simultaneously on each slot, and predicting second traffic distribution for aperiodic traffic, and determining, based on the second traffic distribution, a second transmission probability of the at least two UEs simultaneously on each slot.

In a feasible embodiment, the predicting of the first traffic distribution of periodic traffic includes predicting, by a pre-constructed first neural network, for a UE group, based on historical scheduling information, next scheduling information, and predicting, by a pre-constructed second neural network, based on the historical scheduling information, the next scheduling information, traffic type information and traffic period information, the first traffic distribution of the periodic traffic.

In a feasible embodiment, the predicting of the second traffic distribution of aperiodic traffic includes extracting, by a pre-constructed third neural network, for a UE group, based on historical scheduling information, traffic features, and predicting, by a pre-constructed fourth neural network, based on the traffic features, the second traffic distribution of the aperiodic traffic.

In a feasible embodiment, the determining, based on the simultaneous transmission probability and/or the interference information, of a probabilistic multiplexing gain of the at least two UEs in the UE group includes determining a multiplexing gain of the at least two UEs in the UE group, and determining, based on the simultaneous transmission probability and the multiplexing gain, the probabilistic multiplexing gain of the at least two UEs in the UE group.

In a feasible embodiment, the determining of a multiplexing gain of the at least two UEs in the UE group includes executing, for the at least two UEs in the UE group, the following operations determining spectral efficiency after resource multiplexing by the at least two UEs if there is interference between the UEs, determining spectral efficiency before resource multiplexing by the at least two UEs if there is no interference between the UEs, and determining, based on the spectral efficiency after resource multiplexing and the spectral efficiency before resource multiplexing, the multiplexing gain of the at least two UEs.

In a feasible embodiment, the determining, based on the probabilistic multiplexing gain, of the at least one UE set corresponding to the UE group includes constructing, based on a probabilistic multiplexing gain of at least two UEs in the UE group, an undirected graph of the UE group, where a node in the undirected graph corresponds to a UE in the UE group, and an undirected edge connected between the nodes corresponds to the probabilistic multiplexing gain of the corresponding two UEs, and partitioning the undirected graph by clustering the UEs in the UE group to obtain at least one sub-graph, where the at least one sub-graph corresponds to at least one UE set in the UE group, and a probability of successful multiplexing of at least two UEs in each UE set is greater than that of successful multiplexing of at least two UEs between the UE sets.

In a feasible embodiment, the partitioning of the undirected graph by clustering the UEs in the UE group to obtain at least one sub-graph includes determining, based on a data transmission rate and a transmission probability of the UE on each slot, a sum of data transmission rates of the UEs included in each clustering result in a period corresponding to each slot, and partitioning, based on the sum of the data transmission rates, the undirected graph to obtain the at least one sub-graph.

In a feasible embodiment, the determining of the reserved resource information for each UE set includes executing, for each UE set, one of the following operations determining, for each UE, the number of UEs with which the UE is performing transmission simultaneously, and determining, based on the number of the UEs performing transmission simultaneously and the number of resources required by the UE, reserved resource information, and determining the reserved resource information corresponding to each UE in the UE set, determining, based on the reserved resource information corresponding to each UE, reserved resource information for the UE set, and extending, based on probabilistic multiplexing information, the reserved resource information for the UE set.

In a feasible embodiment, the method further includes processing, based on reserved resource information corresponding to the UE set, traffic of each UE in the UE set, and acquiring traffic processing information, or transmitting the reserved resource information to a second node and receiving traffic processing information fed back by the second node processing, based on the reserved resource information, the traffic of each UE in the UE set, and adjusting, based on traffic processing information, the UE set, and determining the reserved resource information for each adjusted UE set.

In a feasible embodiment, the adjusting, based on traffic processing information, of the UE set, and determining of the reserved resource information for each adjusted UE set includes determining, based on the traffic processing information, a UE set to be adjusted from at least one of the UE sets, partitioning UEs in the UE set to be adjusted to other UE sets to obtain new candidate UE sets, determining second spectral efficiency corresponding to each new candidate UE set, and determining, based on the second spectral efficiency, at least one adjusted UE set from the new candidate UE sets, and determining the reserved resource information corresponding to each adjusted UE set.

In a feasible embodiment, the first node includes at least one of a radio access network controller, a near real-time RAN intelligent controller (Near-RT RIC) of an open radio access network (ORAN) functional module, a non-RT RIC of a service management and orchestration (SMO) module, a distribution unit of the ORAN functional module, a centralized unit of the ORAN functional module, and a base station.

In a feasible embodiment, the second node includes at least one of a radio access network device, a distribution unit of an ORAN functional module, and a base station.

In a feasible embodiment, the reserved resource information includes resource information used for collaboration that indicates with a time domain, a frequency domain and a space domain, and the reserved resource information includes at least one of: resource information reserved for a network slice, and resource information reserved for UE.

In accordance with another aspect of the disclosure, a method performed by a second node in a wireless communication system is provided. The method includes receiving, from a first node, reserved resource information corresponding to a UE group, and processing, based on the reserved resource information, traffic of each UE in the UE group, wherein the UE group includes a group determined based on traffic-related information of UE.

In a feasible embodiment, the traffic-related information includes at least one of delay-related information and period-related information.

In a feasible embodiment, the UE group includes groups obtained by a first node partitioning, based on the traffic-related information, UEs corresponding to a first traffic type.

In a feasible embodiment, the first traffic type includes a traffic type for which a delay requirement for traffic is not greater than a preset first delay threshold value.

In a feasible embodiment, the receiving, from the first node, of the reserved resource information corresponding to a UE group includes receiving reserved resource information corresponding to a UE set, transmitted by the first node, where the UE set includes sets obtained by the first node partitioning, based on resource multiplexing information, a simultaneous transmission probability and/or interference information between UEs, the UE group.

In a feasible embodiment, the processing, based on the reserved resource information, of the traffic of each UE in the UE group includes processing, based on the reserved resource information, traffic of each UE in a UE set to obtain traffic processing information, and feeding back the traffic processing information to a first node, and/or adjusting, based on the traffic processing information, the UE sets, and determining the reserved resource information for each adjusted UE set.

In a feasible embodiment, the adjusting, based on the traffic processing information, of the UE sets, and determining of the reserved resource information for each adjusted UE set include determining, based on the traffic processing information, a UE set to be adjusted from at least one of the UE sets, partitioning UEs in the UE set to be adjusted to other UE sets to obtain new candidate UE sets, determining second spectral efficiency corresponding to each new candidate UE set, and determining, based on the second spectral efficiency, at least one adjusted UE set from the new candidate UE sets, and determining the reserved resource information corresponding to each adjusted UE set.

In accordance with another aspect of the disclosure, a first node in a wireless communication system is provided. The first node includes a transceiver configured to receive and transmit a signal, memory storing one or more computer programs, and one or more processors communicatively coupled to the transceiver, and the memory, wherein the one or more computer programs include computer-executable instructions that, when executed by the one or more processors, cause the first node to acquire traffic-related information of user equipment (UE), determine, based on the traffic-related information, at least one UE group, determine, for each of the at least one UE group, corresponding reserved resource information, and transmit, to a second node, the reserved resource information corresponding to each of the at least one UE group, wherein traffic of each UE in the at least one UE group is processed based on the reserved resource information.

In accordance with another aspect of the disclosure, a second node in a wireless communication system is provided. The second node includes a transceiver configured to receive and transmit a signal, memory storing one or more computer programs stored, and one or more processors communicatively coupled to the transceiver, and the memory, wherein the one or more computer programs include computer-executable instructions that, when executed by the one or more processors, cause the second node to receive, from a first node, reserved resource information corresponding to a user equipment (UE) group, and process, based on the reserved resource information, traffic of each UE in the UE group, wherein the UE group includes a group determined based on traffic-related information of UE.

In accordance with another aspect of the disclosure, one or more non-transitory computer-readable storage media storing one or more computer programs including computer-executable instructions that, when executed by one or more processors of a first node, cause the first node to perform operations are provided. The operations include acquiring traffic-related information of user equipment (UE), determining, based on the traffic-related information, at least one UE group, determining, for each of the at least one UE group, corresponding reserved resource information, and transmitting, to a second node, the reserved resource information corresponding to each of the at least one UE group, wherein traffic of each UE in the at least one UE group is processed based on the reserved resource information.

In accordance with another aspect of the disclosure, one or more non-transitory computer-readable storage media storing one or more computer programs including computer-executable instructions that, when executed by one or more processors of a second node, cause the second node to perform operations are provided. The operations include receiving, from a first node, reserved resource information corresponding to a user equipment (UE) group, and processing, based on the reserved resource information, traffic of each UE in the UE group, wherein the UE group includes a group determined based on traffic-related information of UE.

The technical solutions provided by the embodiments of the disclosure have the following beneficial effects: the embodiments of the disclosure provide methods executed by a first node and a second node, and related devices, and specifically, UE grouping can be performed based on acquired traffic-related information of UE, at least one UE group is determined, and then corresponding reserved resource information is determined for each UE group to process, based on the reserved resource information, traffic of each UE in the UE group, thereby ensuring that reserved resources match traffic requirements of the UE, improving the accuracy of the reserved resources, and effectively meeting the traffic demands.

Other aspects, advantages, and salient features of the disclosure will become apparent to those skilled in the art from the following detailed description, which, taken in conjunction with the annexed drawings, discloses various embodiments of the disclosure,

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 shows a scenario schematic diagram of a dedicated reservation scheme according to an embodiment of the disclosure;

FIG. 2 shows a scenario schematic diagram of a shared reservation scheme according to an embodiment of the disclosure;

FIG. 3 shows a flowchart of a scheme provided according to an embodiment of the disclosure;

FIG. 4A is a flowchart of a method executed by a first node provided according to an embodiment of the disclosure;

FIG. 4B is a flowchart of a method executed by a second node provided according to an embodiment of the disclosure;

FIG. 4C is a flowchart of implementation of a method provided according to an embodiment of the disclosure;

FIG. 5A is a schematic diagram of a reserved collaborative resource space provided according to an embodiment of the disclosure;

FIG. 5B is a schematic diagram of an architecture of a network slice provided according to an embodiment of the disclosure;

FIG. 6A shows a corresponding relationship between UE groups and a reserved collaborative resource space according to an embodiment of the disclosure;

FIG. 6B shows a schematic diagram of mapping a resource reservation policy for a UE group according to an embodiment of the disclosure;

FIG. 6C shows a configuration schematic diagram of a resource reservation policy according to an embodiment of the disclosure;

FIG. 6D shows a schematic diagram of mapping a resource reservation policy for a UE group according to an embodiment of the disclosure;

FIG. 7 is a schematic diagram of an overlap decision method for a time-frequency-space domain provided according to an embodiment of the disclosure;

FIG. 8A is a schematic diagram of a 2D resource grid provided according to an embodiment of the disclosure;

FIG. 8B is a schematic diagram of a 3D resource grid provided according to an embodiment of the disclosure;

FIG. 8C is a schematic diagram of another 3D resource grid provided according to an embodiment of the disclosure;

FIG. 9A is a schematic diagram of an MU-SM-based implementation scheme provided according to an embodiment of the disclosure;

FIG. 9B is a schematic diagram of another MU-SM-based implementation scheme provided according to an embodiment of the disclosure;

FIG. 9C is a schematic diagram of a resource reservation scheme provided according to an embodiment of the disclosure;

FIG. 10A is a schematic diagram corresponding to CRS construction and resource reservation policy generation shown in FIG. 9A according to an embodiment of the disclosure;

FIG. 10B is a schematic diagram of CRS construction and resource reservation policy generation provided according to an embodiment of the disclosure;

FIG. 11 is a schematic diagram for partitioning a UE group provided according to an embodiment of the disclosure;

FIG. 12A is a schematic diagram of normal distribution of scheduling request receiving times provided according to an embodiment of the disclosure;

FIG. 12B shows a schematic diagram of performing resource reservation for periodic traffic according to an embodiment of the disclosure;

FIG. 13 shows a schematic diagram of performing resource reservation for aperiodic traffic according to an embodiment of the disclosure;

FIG. 14 is a schematic diagram of predicting UE data packet distribution via AI provided according to an embodiment of the disclosure;

FIG. 15 is a schematic diagram of determining a probabilistic multiplexing gain provided according to an embodiment of the disclosure;

FIG. 16 shows a schematic diagram of partitioning a UE group to obtain several UE sets according to an embodiment of the disclosure;

FIG. 17A is a schematic diagram of a coordinative RB resource provided according to an embodiment of the disclosure;

FIG. 17B is a schematic diagram of another coordinative RB resource provided according to an embodiment of the disclosure;

FIG. 18 shows a schematic diagram of extending the number of minimum RBs of a UE set according to an embodiment of the disclosure;

FIG. 19 is a schematic diagram of an architectural layout provided according to an embodiment of the disclosure;

FIG. 20A is a schematic diagram of another architectural layout provided according to an embodiment of the disclosure;

FIG. 20B is a flowchart of a method corresponding to the architecture shown in FIG. 20A according to an embodiment of the disclosure;

FIG. 21A is a schematic diagram of a resource adjustment provided according to an embodiment of the disclosure;

FIG. 21B is a schematic diagram of another resource adjustment provided according to an embodiment of the disclosure;

FIG. 21C is a schematic diagram of still yet another resource adjustment provided according to an embodiment of the disclosure;

FIG. 22 is a flowchart of a method provided according to an embodiment of the disclosure; and

FIG. 23 is a structural schematic diagram of an electronic device provided according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces. When an element is referred to be “connected to” or “coupled to” to another element, this element may be directly connected to or coupled to the another element, or this element may be connected to the another element through an intermediate element. Further, “connection” or “coupling” used herein may include wireless connection or wireless coupling.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain feature, number, step, operation, constituent element, component or a combination thereof, but may not be construed to exclude the existence of or a possibility of addition of one or more other features, numbers, steps, operations, constituent elements, components or combinations thereof.

The term “or” used in various embodiments of the disclosure includes any or all of combinations of listed words. For example, the expression “A or B” may include A, may include B, or may include both A and B. When describing multiple (two or more) items, if the relationship between multiple items is not explicitly limited, the multiple items can refer to one, many or all of the multiple items. For example, the description of “parameter A includes A1, A2 and A3” can be realized as parameter A includes A1 or A2 or A3, and it can also be realized as parameter A includes at least two of the three parameters A1, A2 and A3.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

At least some of the functions in the apparatus or electronic device provided in the embodiments of the disclosure may be implemented by an Artificial Intelligence (AI) model. For example, at least one of a plurality of modules of the apparatus or electronic device may be implemented through the AI model. AI-related functions may be performed by non-volatile memories, volatile memories and processors.

The processor may include one or more processors. In this case, the one or more processors may be general-purpose processors such as central processing units (CPUs), application processors (APs), etc., or pure graphics processing units such as graphics processing units (GPUs), visual processing Units (VPUs), and/or AI-specific processors such as neural processing units (NPUs).

The one or more processors control the processing of the input data according to the predefined operation rule or AI model stored in the non-volatile memory and the volatile memory. The pre-defined operating rules or artificial intelligence models are provided through training or learning.

Here, providing by learning means that the predefined operation rule or AI model with desired features is obtained by applying a learning algorithm to multiple pieces of learning data. The learning may be executed in an apparatus or an electronic device in which the AI according to the embodiments is executed, and/or may be implemented by a separate server/system.

The AI model may contain multiple neural network layers. Each layer has a plurality of weights. Each layer performs the neural network computation by computation between the input data of that layer (e.g., the computation results of the previous layer and/or the input data of the AI models) and the plurality of weight values of the current layer. Examples of the neural network include, but not limited to: convolutional neural networks (CNNs), deep neural networks (DNNs), recurrent neural networks (RNNs), restricted Boltzmann machines (RBMs), deep belief networks (DBNs), bidirectional recurrent deep neural networks (BRDNNs), generative adversarial networks (GANs) and deep Q networks.

The learning algorithm is a method of training a predetermined target apparatus (e.g., a robot) by using multiple pieces of learning data to enable, allow or control the determination or prediction of the target apparatus. Examples of the learning algorithm include, but are not limited to, supervised learning, unsupervised learning, semi-supervised learning, or reinforcement learning.

According to the disclosure, at least one step executed in a first node, such as a step of determining, for each UE group, corresponding reserved resource information and the like, can be implemented using an artificial intelligence model. A processor of the first node can execute a preprocessing operation on data to convert the data into a form suitable for being used as input of the artificial intelligence model. The artificial intelligence model can be obtained by training. Here, “obtained by training” means that a basic artificial intelligence model is trained with multiple pieces of training data by a training algorithm to obtain a predefined operation rule or artificial intelligence model configured to execute a desired feature (or purpose).

In the disclosure, 5G and 5.5G technologies are involved, considering that 5G and 5.5G communication systems are under pressure to meet the demands of uplink delay critical traffics, there are often strict delay requirements in emerging applications and vertical markets, such as augmented reality and medical care.

With an increasing demand for delay critical traffic, requirements for slice management (also known as resource management) are becoming more and more challenging.

Radio Access Network (RAN) slicing is a technology to support delay critical traffic by customizing resource partitioning, allocation and priority for slices. Multiple dedicated, virtualized, isolated logical networks can be constructed on a universal physical network, each of which can obtain logically independent network resources to meet differentiated requirements of different customers for network capabilities, thereby implementing on-demand networking.

For network slicing in the related art, it is implemented by adopting the following schemes:

1. A Physical Resource Block (PRB) of each slice is proportionally allocated to a Distributed Unit (DU) by a near real-time RAN intelligent controller (Near-RT RIC).

2. DU performs uplink and downlink scheduling for different slices in a Min-Max proportion. A delay of delay critical traffic is guaranteed only by using scheduling.

3. Scheduling statistical data will be fed back to the Near-RT RIC to optimize a resource proportion.

In order to guarantee transmission of the uplink delay critical traffic in the network slicing, many concepts and suggestions are proposed to support transmission of delay critical traffic with a high resource priority. However, due to limitations of time-frequency-space domain resources and scheduling capability, different problems are encountered in example applications.

For example, in dynamic scheduling, UE triggers a dynamic scheduling request when a data packet arrives, and gNB forces a high priority to be added to a delay critical traffic bearer when receiving the scheduling request. However, the high-priority dynamic scheduling method adds a high weight to the delay critical traffic bearer, but a transmission delay cannot be guaranteed due to a relatively long dynamic request time. Specifically, it is required that a terminal firstly transmits an Scheduling Request (SR), then is scheduled to transmit a buffer status report (BSR) to indicate a buffer occupied (BO) size (traffic volume), and then schedules uplink data according to the BO size. Since the dynamic scheduling requires SR resources, when there is a great demand for access, limitation of the SR resources will cause a delay of the delay critical traffic to become large. Accordingly, the limited SR resources cause the SR for the delay critical traffic to fail to be transmit in time, resulting in a large delay. Limitation of network scheduling capacity will cause the delay of the delay critical traffic to be large. The Distributed Unit (DU) has a limit on the number of pre-scheduling and parallel scheduling. Alternatively, when repetitive scheduling is performed for other User Equipments (UEs), the resources cannot be used immediately, and the delay critical traffic cannot be scheduled, resulting in a large delay.

For example, in a grant-free policy, the gNB reserves resources in advance and notifies the UE through a configured grant, and when a data packet arrives, the UE immediately transmits the data packet. The grant-free scheduling methods generally includes two schemes: a dedicated reservation scheme and a shared reservation scheme.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

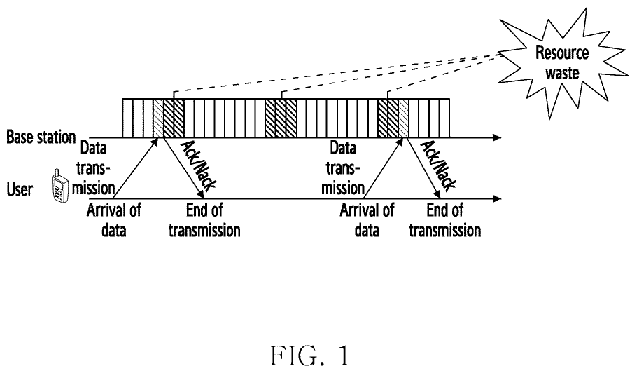

FIG. 1 shows a scenario schematic diagram of a dedicated reservation scheme according to the related art.

Referring to FIG. 1, in the dedicated reservation scheme, one UE is configured to be grant-free, and the UE fully uses grant-free resources; and multiple UEs are configured to be grant-free, and time domain and frequency domain resources are completely staggered and independent of each other. In this scheme, since the gNB does not know the exact generation time and data amount of UE data, sufficient resources are reserved based on a grant-free dedicated reservation for each UE to ensure that the data packet can be transmitted immediately upon arrival. However, due to inaccurate arrival time and data amount, an Uplink (UL) cannot obtain accurate BO information, then implementing the grant-free policy requires to continuously reserve resources for the delay critical traffic for a long time, resulting in waste caused by reserving more resources and low resource utilization.

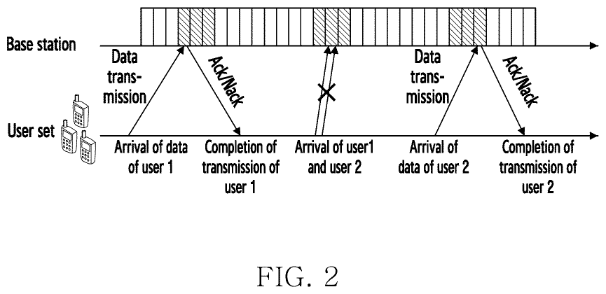

FIG. 2 shows a scenario schematic diagram of a shared reservation scheme according to the related art.

Referring to FIG. 2, in the shared reservation scheme, multiple UEs are configured to be grant-free, and time domain and frequency domain resources are the same or overlapped, which may result in transmission failure due to a conflict. In order to avoid resource waste, a way that a group of UEs shares same grant-free resources is adopted in this scheme, but when the multiple UEs collide due to simultaneous transmission, resulting in data transmission failure.

Cases related to the above-mentioned grant-free policy cause the following problems as shown in Table 1:

TABLE 1

| | Resource waste | Conflict & Failure |
|---|---|---|
| Dedicated reservation | ✓ | |
| Arbitrary resource sharing | | ✓ |

In addition, during data processing, since the DU/UE needs to perform cross-layer processing, and time of cross-layer processing needs to be considered for completing data transmission, a delay requirement for the delay critical traffic is higher.

It can be seen therefrom that there is a need to provide a more flexible resource reservation and scheduling mechanism, and effectively balances resource waste and a low delay guarantee.

Aiming at the problems existing in the related art or areas where improvements are required, the disclosure proposes a grant-free collaborative resource spaces (CRS)-based delay critical traffic management scheme, which can be specifically applied to scenarios such as resource management, processing of uplink delay critical traffic, and network slice deployment. According to traffic properties, a channel correlation and the like, a shared grant-free collaborative resource space is set for the delay critical traffic, thereby avoiding delay scheduling, and effectively guaranteeing a low delay.

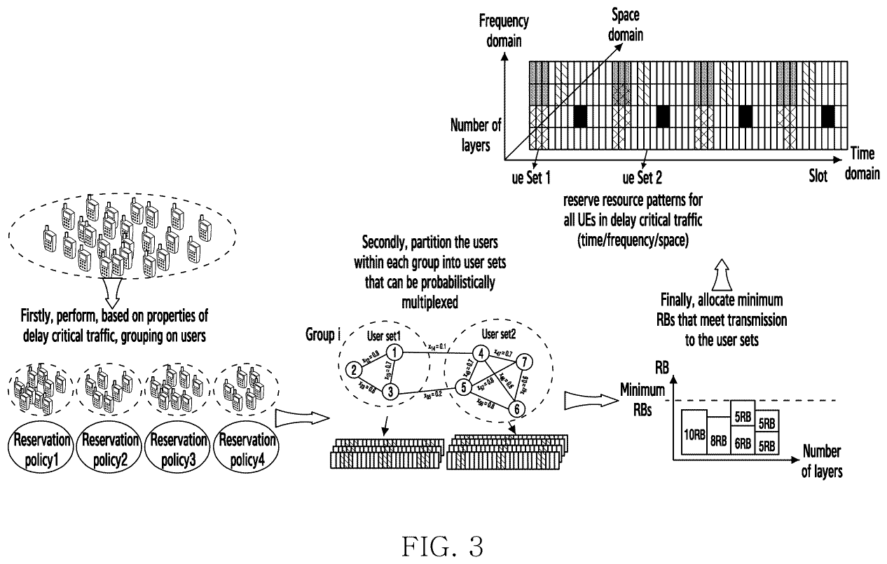

FIG. 3 shows a flowchart of a scheme provided according to an embodiment of the disclosure.

Referring to FIG. 3, the scheme proposed by the disclosure may include the following three parts 3:

(1) In order to guarantee the service performance requirement and guarantee the accuracy of resource reservation, UE grouping is performed. Specifically, UE grouping is performed based on traffic features (such as period) and performance requirements (such as delay), and a precise resource reservation policy is designed according to properties and performance requirements of each group, which guarantees that least resources can be allocated to the UE groups when resources are allocated without scheduling in a case where service performance requirements are met.

(2) In order to allocate the least resources on the premise of guaranteeing reliable transmission, set partitioning are performed on UEs which meet the requirement of probabilistic multiplexing transmission. A UE group may include multiple probabilistic multiplexing transmission UE sets (user sets). It is required the UEs in a same set have a relatively high simultaneous transmission probability and relatively low multi-UE interference, which can implement reduced reserved resources and guarantee the reliability of transmission.

(3) In order to reduce resource waste, resource orchestration is performed on the UEs in a same set in frequency domain and space domain to allocate the least RB resources on the basis of meeting the RB demand of each UE.

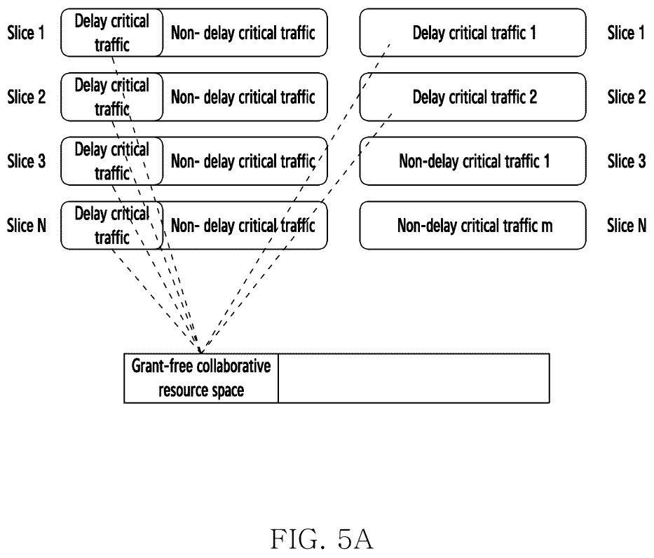

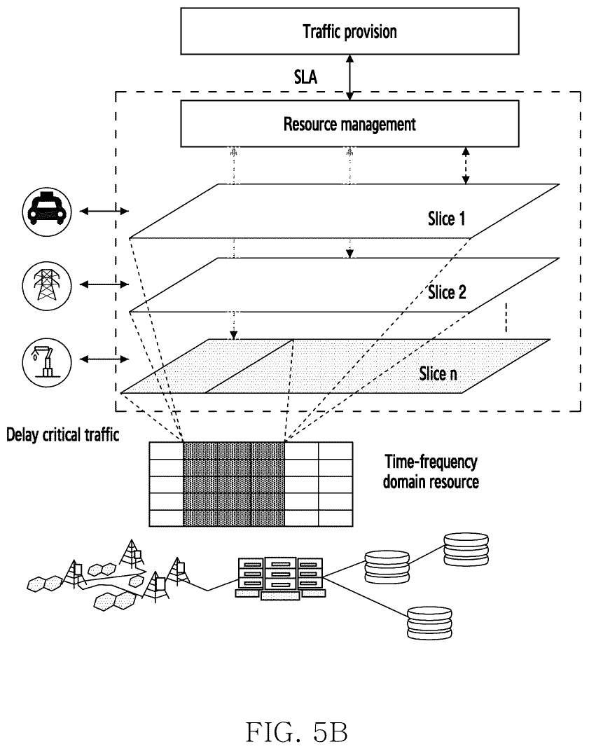

In an embodiment of the disclosure, CRS is a group of UEs, and the UEs in the group uses a same resource reservation policy. The resource reservation policy is defined as reserving 3D resources in time domain, frequency domain and space domain according to particular UE traffic features. Each resource reservation policy has a particular resource. CRS is defined as a formula CRS≙ω(x, c→p), where x=x₁, x₂, . . . and ∀xᵢ∈x are UE traffic feature samples, and different xᵢ (xᵢ∈x) constitute a collaborative feature cᵢ, namely, c; is collaboratively composed of ∀xᵢ∈x and C= {c₁, c₂, . . . }, pᵢ is a resource reservation policy corresponding to the collaborative feature cᵢ, and p={p₁, p₂, . . . }. Network slicing is an effective way to make multiple virtual and isolated logical networks run more efficiently on a common physical infrastructure. Considering specific service requirements (delays, data packet sizes, data packet errors and the like) of delay critical traffic, in a network slicing scenario, one or several slices can be established by coordination of network slicing in the disclosure, and different zones with the delay critical traffic will be multiplexed in a same resource through uniform resource coordination, as shown in FIG. 5B.

It is considered that a delay critical traffic set D=(D_{d}) is all delay critical traffic types supported in the network, while a slice set S=(Sₛ) is coordinated to support different delay critical traffic. One or more types of delay traffic can be mapped to a same zone D_{d}→Sₛ. Therefore, a UE having one or more delay critical traffic types can be configured as one or more slices.

For networks, an uplink OFDMA system is considered, where cellular gNB is uniformly distributed. Each gNB is partitioned into 3 sectors. The UEs are randomly distributed in a gNB serving cell, and a 3D-SCM fading channel is adopted in a system model.

The technical solutions of the embodiments of the disclosure and the technical effects produced by the technical solutions of the disclosure will be explained below by describing several implementations. It should be pointed out that the following embodiments may be referred to each other, learn from each other, or combined with each other, and the same terms, similar features and similar implementation steps in different implementations will not be repeated.

A resource reservation method provided by an embodiment of the disclosure will be described below.

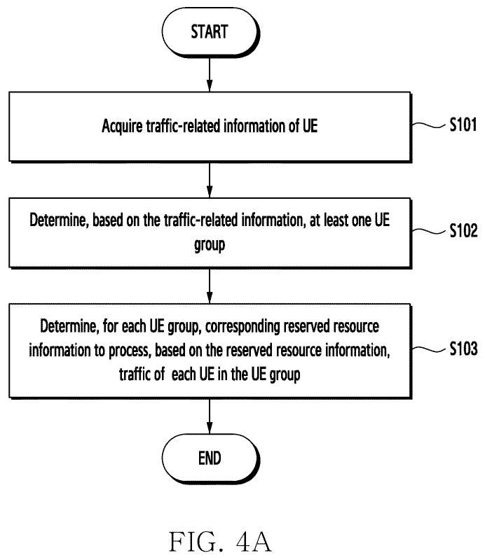

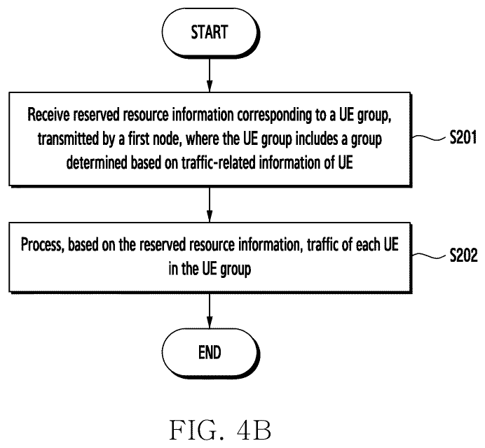

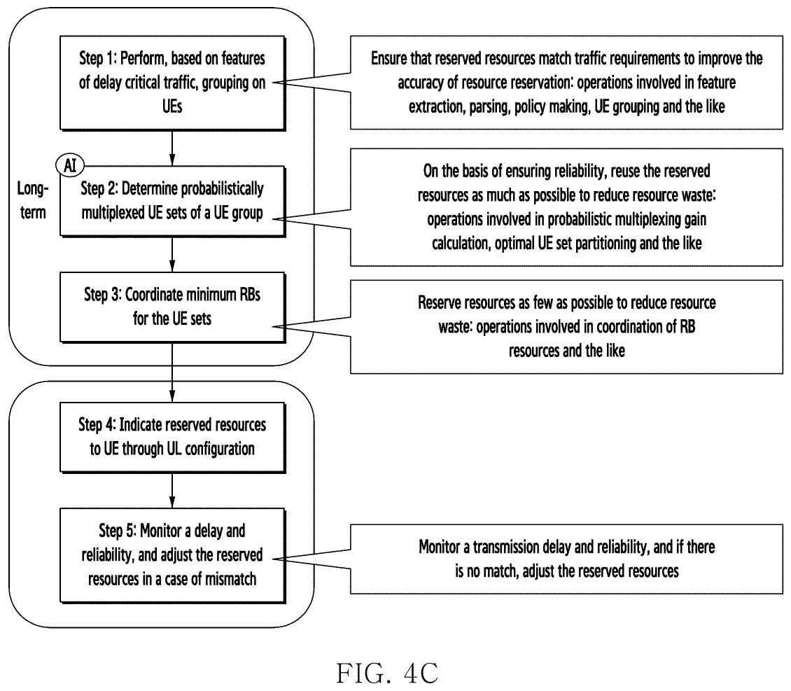

FIG. 4A is a flowchart of a method executed by a first node provided according to an embodiment of the disclosure.

FIG. 4B is a flowchart of a method executed by a second node provided according to an embodiment of the disclosure.

FIG. 4C is a flowchart of implementation of a method provided according to an embodiment of the disclosure.

Specifically, as shown in FIG. 4A, a method executed by a first node provided by an embodiment of the disclosure includes the following operations S101 to S103:
operation S101: acquire traffic-related information of UE;
operation S102: determine, based on the traffic-related information, at least one UE group; and
operation S103: determine, for each UE group, corresponding reserved resource information to process, based on the reserved resource information, traffic of each UE in the UE group.

The traffic-related information of the UE may include related information involved in processing the traffic of the UE, such as traffic properties and a channel correlation. Specifically, the related information may be a traffic attribute parameter, a traffic reporting parameter, a transmission performance parameter and the like, where the traffic attribute parameter and the traffic reporting parameter may include period information, a traffic packet size, a delay requirement and the like, and the transmission performance parameter may include a bit error rate, the number of MU (Multi-user) multiplexing layers and the like.

Optionally, the traffic-related information may include at least one of delay-related information and period-related information. The delay-related information may include information such as the delay requirements, and the period-related information may include information such as information indicating whether traffic is periodic traffic, and a period size corresponding to the periodic traffic.

Optionally, when the at least one UE group is determined based on the traffic-related information, the method includes: partitioning, based on the traffic-related information, UEs corresponding to a first traffic type into the at least one UE group.

Optionally, the traffic can be partitioned into a first traffic type, a second traffic type and the like by type, and UEs corresponding to the first traffic type can be partitioned into the at least one UE group. The first traffic type may include a traffic type for which a delay requirement for traffic is not greater than a preset first delay threshold value, and may be referred to as a delay critical traffic type, and the second traffic type may include a traffic type for which a delay requirement for traffic is greater than the first delay threshold value, and may be referred to as a non-delay critical traffic type.

A reserved resource is also referred to as a grant-free resource, a shared grant-free resource, a grant-free shared resource, a reserved collaborative resource, a grant-free collaborative resource and the like in the embodiments of the disclosure, and it may be a resource reserved for particular traffic, namely, a grant-free resource. A corresponding reserved resource can be used when a task of the particular traffic is executed, delay scheduling is avoided to meet the delay requirement of the traffic.

Optionally, the disclosure can be implemented for various types of traffic having a requirement for a delay, for example, for all delay critical traffic, and a corresponding reserved resource may be composed of reserved time-frequency-space domain resources of the delay critical traffic of all UEs, and the reserved resources can be stored with a resource space or resource pool for collaboration. Reserved resource information (also referred to as reserved collaborative resource information) may include information involved in calling a corresponding reserved resource, such as resource space information used for collaboration that indicates a 3D space having time domain, frequency domain and space domain dimensions.

Optionally, the reserved resource information may include at least one of: resource information reserved for a network slice, and resource information reserved for a UE.

In a feasible embodiment, the determine, for each UE group, corresponding reserved resource information in operation S103 includes:
determining, for a same UE group of different network slices, the corresponding reserved resource information; or
determining, for a same UE group of a same network slice, the corresponding reserved resource information.

Network slicing can be performed for one slice or for multiple slices. In a slice deployment scenario, traffic of UEs of different slices or traffic of different UEs within a same slice can be transmitted via same reserved resource information.

FIG. 5A is a schematic diagram of a reserved collaborative resource space provided according to an embodiment of the disclosure.

FIG. 5B is a schematic diagram of an architecture of a network slice provided according to an embodiment of the disclosure.

For a slice multiplexing scenario, such as a slice deployment scenario as shown on the left side of FIG. 5A, a grant-free collaborative resource space (also referred to as a shared resource pool, a reserved resource pool, a grant-free resource pool, a shared grant-free resource pool and a reserved collaborative resource space) supports cross-slice multiplexing. After grant-free resources required by all delay critical traffic of each slice are assessed, a grant-free shared collaborative resource space is determined, and multiple slices can multiplex time-frequency-space resources determined by the shared grant-free collaborative resource space. For example, resources in the grant-free collaborative resource space can be adopted by both delay critical traffic of the UE involved in slice 1 and delay critical traffic of the UE involved in slice 2.

For an intra-slice multiplexing scenario, such as a slice deployment scenario as shown on the right side of FIG. 5A, the grant-free collaborative resource space may also be dedicated to one or more delay critical slices. After grant-free resources required by all traffic of each delay critical slice (namely, all the traffic of all UEs within a same slice, such as slice 1 and slice 2, is delay critical traffic; or all the traffic of all UEs within a same slice, such as slice 3 and slice N, is non-delay critical traffic) are assessed, a grant-free collaborative resource space is determined, and a UE with the delay critical traffic within the slice can multiplex the time-frequency-space domain resources determined by the grant-free collaborative resource space.

Optionally, the UE group (also referred to as a grant-free group, and a delay critical UE group S) may include all UE groups with the delay critical traffic. The grant-free collaborative resource space is composed of reserved resources of delay critical traffic for all UEs in the UE group S. Each UE group has respective corresponding reserved resource information, and the reserved resource information corresponds to collaborative resource space information. Each collaborative resource space has a particular resource reservation policy corresponding to traffic properties.

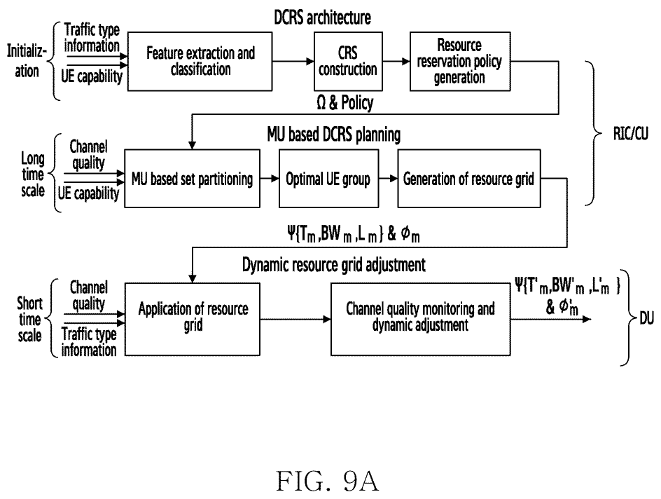

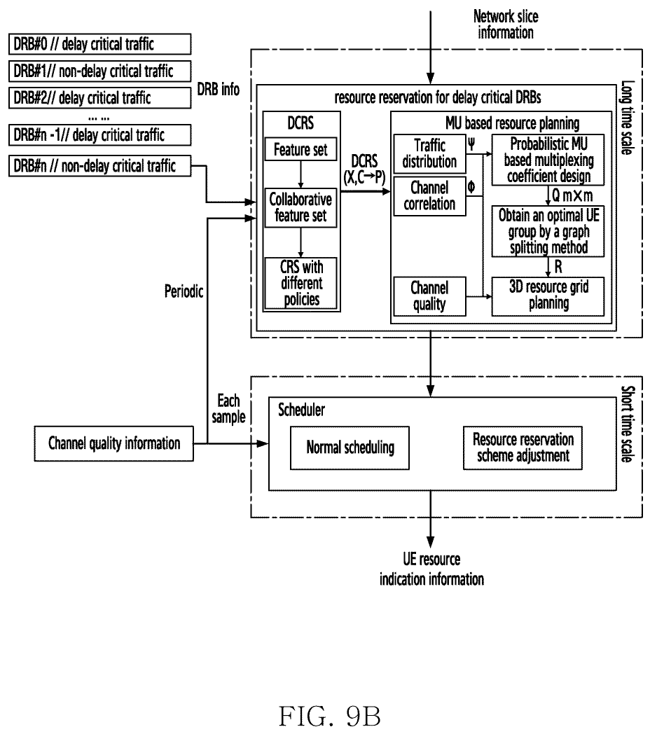

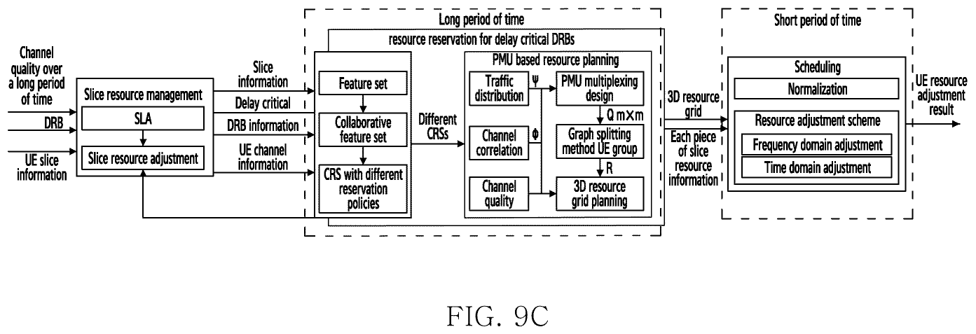

FIG. 9A is a schematic diagram of an MU-SM-based implementation scheme provided according to an embodiment of the disclosure.

FIG. 9B is a schematic diagram of another MU-SM-based implementation scheme provided according to an embodiment of the disclosure.

FIG. 9C is a schematic diagram of a resource reservation scheme provided according to an embodiment of the disclosure.

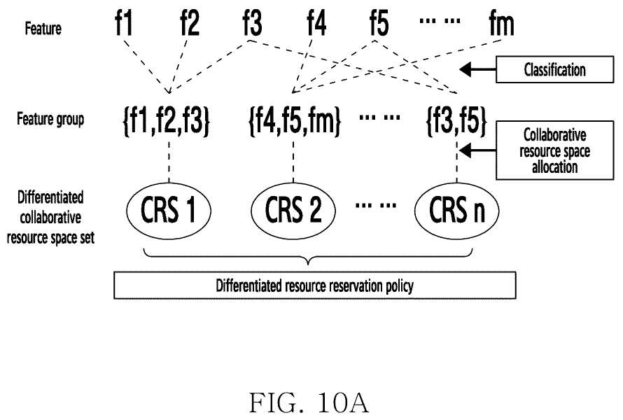

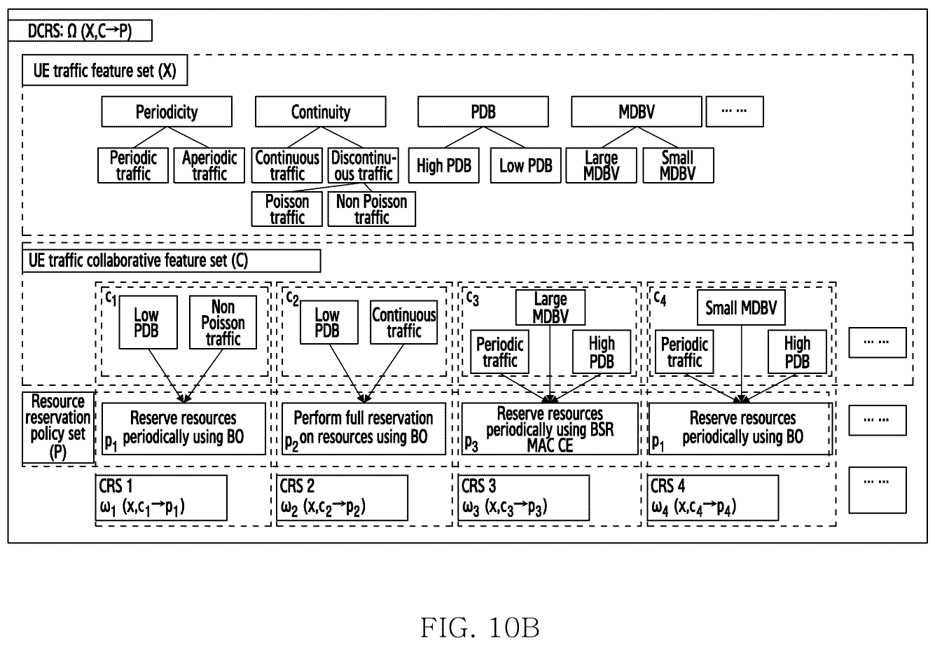

FIG. 10A is a schematic diagram corresponding to CRS construction and resource reservation policy generation shown in FIG. 9A according to an embodiment of the disclosure.

FIG. 10B is a schematic diagram of CRS construction and resource reservation policy generation provided according to an embodiment of the disclosure.

Referring to Branch 1 of FIGS. 9A, 9B, and 10A, in order to meet transmission requirements of corresponding groups of different CRSs, an embodiment of the disclosure proposes a differentiated collaborative resource space (DCRS) architecture. Considering that different features are concerned when a DCRS is constructed, different attributes can be defined to mark different CRSs (CRS tags). The establishment of the CRS enables the scale of resource reservation to be reduced through a differentiated reservation policy. A same reserved resource can be allocated to traffic in a same CRS, and all the CRSs form a DCRS set. The DCRS is a set of CRSs, including different resource reservation policies. The definition of the DCRS is given by the formula DCRS ≙Ω(X,C→P), where X is a set of UE traffic features, X=Uᵢ₌₀ⁿxᵢ. C is a set of collaborative features, C={c₁, c₂, c₃, . . . }. P is a set of resource reservation policies corresponding to the collaborative features, P={p₁, p₂,p₃, . . . }. Each collaborative feature is related to only one resource reservation policy, and one policy can be applied to different collaborative features. The resource reservation policies are independent of each other. The establishment of a DCRS architecture can avoid excessive resource reservation on the basis of guaranteeing a delay, in order to reduce the size of the reserved resource. The features are traffic-related properties, such as delays, periods, data sizes and UE capability. These properties can be partitioned to different feature groups (UE groups) according to different traffic requirements. Each feature group may be assigned a CRS (allocating a corresponding reserved resource), and each CRS has a dedicated resource reservation policy. The DCRS is constructed through the collaborative features of traffic by adopting corresponding resource reservation policies. The construction of the DCRS is as shown in FIG. 10B. In FIG. 10B, collaborative feature c₁ is collaboration between low-PDB (Packet Delay Budget, also referred to as a delay requirement) feature and a non-poisson traffic feature, c₂ is collaboration between the low-PDB feature and a continuous traffic feature, c₃ is collaboration of large-MDBV (Maximum Data Burst Volume), high-PDB and periodic traffic features, and c₄ is collaboration of small-MDBV, high-PDB and periodic traffic features.

In an embodiment of the disclosure, the following related traffic properties are proposed for delay critical traffic:

(1)PDB: PDB represents an upper time limit that a data packet between UE and a UPF that terminates an N6 interface may be delayed. For the delay critical traffic, if a data burst volume does not exceed a maximum data burst volume (MDBV) during PDB, and a QoS stream does not exceed a GFBR (Guaranteed Flow Bit Rate), a data packet with a delay exceeding the PDB is calculated as lost. The PDB includes a core network packet delay budget (CN PDB) and a radio access network PDB (RAN PDB). The RAN PDB is configured to support scheduling and configuration of link layer functions. ρ,ε represent total PDB and CN PDB, then RAN PDBτ may be represented as τ≤ρ−ε.

(2) MDBV (Maximum Data Burst Volume): MDBV represents a maximum data amount that an RAN needs to provide within the RAN PDB. The MDBV represents a BO of a delay critical traffic bearer. BO; represents BO information of delay critical traffic of UE i.

(3) Continuity: If traffic is continuous, it means that the data packets are transmit continuously in time dimension. Otherwise, the traffic has a discontinuous property.

(4)Periodicity: Periodicity describes whether the delay critical traffic is periodic in time dimension. For an uplink, even if the UE generates strict periodic delay critical traffic, it is difficult for gNB to predict the generation time of the data packet. In an embodiment of the disclosure, modelling is performed on periodic delay critical traffic and aperiodic delay critical traffic respectively. The data packet generation time for periodic uplink delay critical traffic is modeled as normal distribution per T, and its probability density function is defined as

$$f ( t ) = \frac{1}{\sqrt{2 π} σ} {e}^{- \frac{{( t - μ )}^{2}}{2 {σ}^{2}}} ,$$

μ=tᵢₙᵢ+nT.

tᵢₙᵢ is initial time when a data packet is generated. Since UE may have more than one piece of delay critical traffic, it may be multi-periodic. To simplify operations, a mono-periodic model may be adopted.

The aperiodic delay critical traffic corresponds to emergency scenarios, such as emergency braking and fault alarming. In an embodiment of the disclosure, Poisson distribution is used for simulating data packet generation for aperiodic traffic, where a time moment of data packet generation is random, with an average data packet interval. It is assumed that the number of the data packets per millisecond (ms) is λ, and the number of slots per ms is tₛ. An average arrival rate per slot is λ′=[λ/tₛ]. Its probability function is defined as:

$$P ( x = k ) = \frac{{( {λ}^{′} )}^{n}}{n !} * {e}^{- {λ}^{′}} ,$$

n=0,1,2, . . .

In an embodiment of the disclosure, different resource reservation policies are adopted for different CRSs. Pieces of traffic with a same collaborative property belong to a same CRS, and these pieces of traffic may belong to a same slice or different slices. A same resource reservation policy is used in one CRS, and resources are co-allocated to bearers belonging to the CRS. Since one UE may have multiple pieces of traffic, and each piece of traffic has its own 5QI requirement, in order to simplify a subsequent resource reservation method, it can be assumed that the CRS to which the UE belongs is a CRS to which traffic having the strictest 5QI requirement belongs. In the construction of a DCRS, pieces of traffic with similar transmission requirements are classified into one CRS to minimize the scale of a reserved resource.

It is assumed that a threshold value of a PDB is Tr_{PDB}; traffic with a high PDB is defined as PDB>Tr_{PDB}, and traffic with a low PDB is defined as PDB≤Tr_{PDB}. It is assumed that an MDBV threshold value is Tr_{MDBV}. Traffic with a large MDBV is defined as MDBV>Tr_{MDBV}, and traffic with a small MDBV is defined as MDBV≤Tr_{MDBV}. Periodic traffic is represented with Peri, and aperiodic traffic is represented with Aperi. Continuity and discontinuity are represented as Con and Dcon, respectively. Poisson traffic is represented as Dcon_{Po}.

The DCRS of slice-based delay critical traffic in an uplink is constructed by collaborating traffic properties of the UE and adopting a corresponding resource reservation policy, as shown in FIG. 10B.

According to collaborative properties, the disclosure proposes resource reservation policies for constructing a DCRS, as shown in FIG. 10B. For collaborative property c₁, policy p₁ is used for reserving resources using a periodic BO. For collaborative property c₂, policy p₂ is used for reserving resources through a BO used persistently. For collaborative property c₃, policy p₃ is used for reserving minimum resources through BSR MAC CE used periodically to guarantee a delay and meet huge requirements. For collaborative property c₄, the same as c₁, policy p₁ is used for reserving resources through a BO used periodically, such that a data packet can be transmit immediately to meet the delay requirements.

In the disclosure, UE traffic properties and resource reservation policies corresponding to the collaborative properties are proposed. Since these properties and policies can be extended, the DCRS accordingly has extendibility, and can be used for delay critical traffic.

In an embodiment of the disclosure, also considering a case of an extremely low delay, a low delay, periodic traffic, burst traffic or the like, as shown in FIG. 10A, a differentiated resource reservation policy for different level demands is provided, where differentiated CRSs can be grouped by adopting a differentiated reservation policy (a BSR MAC CE size or a data packet size, periodicity or a delay requirement can be considered) to reduce reservation of resources in a case where traffic delay requirements are guaranteed.

In an embodiment of the disclosure, UEs can be grouped according to traffic properties of current delay critical traffic of the UEs, and an accurate resource reservation policy is formulated and applied for the UEs in a same group to improve resource utilization.

The related content of the differentiated reservation policy in the embodiments of the disclosure will be explained below.

In an embodiment of the disclosure, considering that there may be multiple types of delay critical traffic, and different delay critical traffic has differences in the period properties and delay critical level, it is possible to partition all UEs with traffic delay critical into multiple delay critical UE groups and correspondingly partition grant-free resources reserved by all the UEs with traffic delay critical into multiple grant-free collaborative resource spaces.

The UE group may include at least one of:
a first UE group for which a delay requirement for traffic is not greater than a preset second delay threshold value and the traffic is periodic traffic;
a second UE group for which a delay requirement for traffic is not greater than the preset second delay threshold value and the traffic is aperiodic traffic;
a third UE group for which a delay requirement for traffic is greater than the preset second delay threshold value and the traffic is the periodic traffic; and
a fourth UE group for which a delay requirement for traffic is greater than the preset second delay threshold value and the traffic is the aperiodic traffic.

Specifically, the following several delay critical UE groups {Si} can be obtained by partitioning:

delay critical UE group S1: periodic traffic, with a delay requirement <=1 ms (second delay threshold value)
delay critical UE group S2: periodic traffic, with 1 ms<a delay requirement <=10 ms
delay critical UE group S3: aperiodic traffic, with a delay requirement <=1 ms
delay critical UE group S4: aperiodic traffic, with 1 ms<a delay requirement <=10 ms

The above several sets are only some examples, and groups obtained by partitioning with respective to the delay requirements and/or the period properties can be regarded as partitioning results that can be by the embodiments of the disclosure.

Optionally, operation of determining, for each UE group, corresponding reserved resource information in operation S103 includes at least one of:
for the first UE group and/or the second UE group, determining, based on resource information required for performing traffic data transmission, the reserved resource information; and
for the third UE group and/or the fourth UE group, determining, based on resource information required for resource scheduling, the reserved resource information.

The reserved resource information can be determined based on the resource information required for traffic data transmission, for the above-mentioned UE groups with a higher traffic delay requirement, namely, the UE groups that the traffic delay requirement is not greater than the second delay threshold value. The reserved resource information can be determined based on the resource information required for resource scheduling, for the above-mentioned UE groups with a lower traffic delay requirement, namely, the UE groups that the traffic delay requirement is greater than the second delay threshold value.

Optionally, the resource information required for resource scheduling may include resource information corresponding to a scheduling request (SR) and/or a buffer status report (BSR).

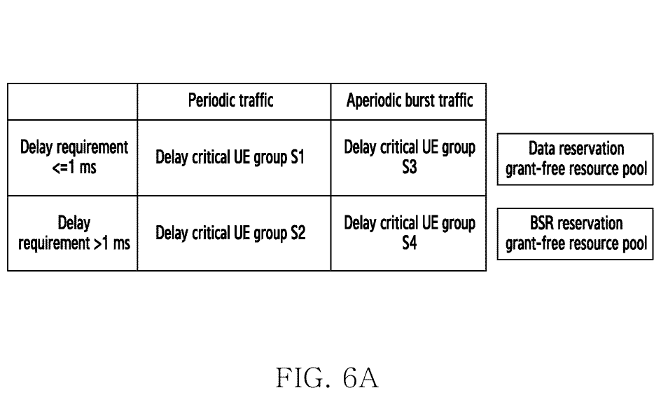

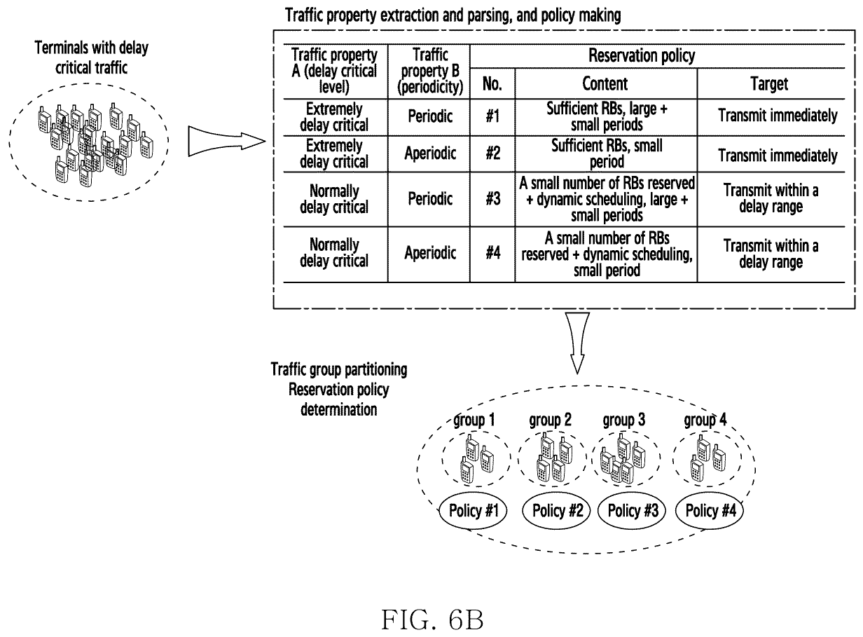

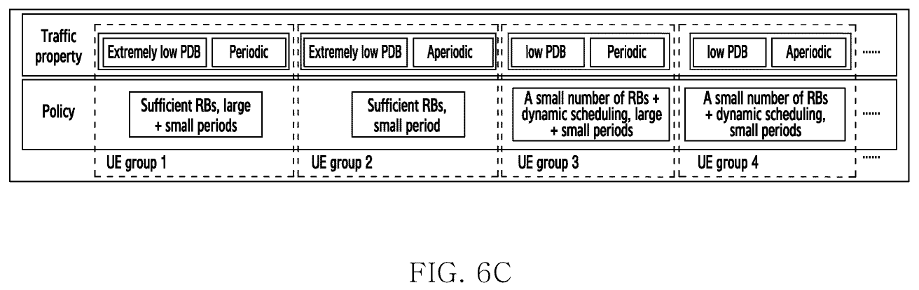

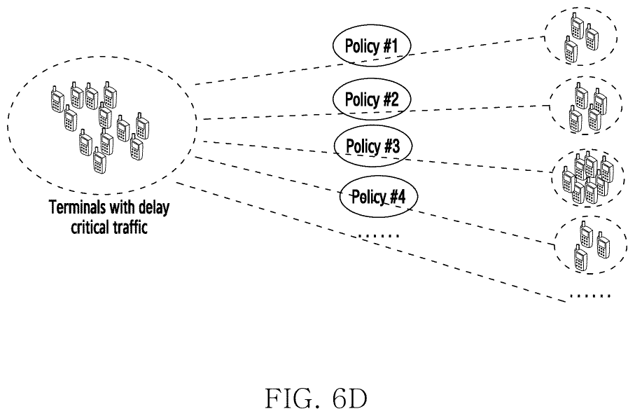

FIG. 6A shows a corresponding relationship between UE groups and a reserved collaborative resource space according to an embodiment of the disclosure.

FIG. 6B shows a schematic diagram of mapping a resource reservation policy for a UE group according to an embodiment of the disclosure.

FIG. 6C shows a configuration schematic diagram of a resource reservation policy according to an embodiment of the disclosure

FIG. 6D shows a schematic diagram of mapping a resource reservation policy for a UE group according to an embodiment of the disclosure.

For the critical level of the delay critical traffic on the delay requirement, an embodiment of the disclosure further proposes a differentiated grant-free resource reservation method, that is, in an example case, grant-free reservation can be performed on data, and in another example case, grant-free reservation can be performed based on BSR and dynamic scheduling can be superimposed. As shown in FIG. 6A, for extremely delay critical traffic (such as traffic with a delay requirement of less than 1 ms), if SR/BSR scheduling is performed, the traffic delay requirement cannot be met, and for such traffic, transmission resources required for traffic data transmission can be directly reserved. For delay relatively critical traffic (such as traffic with 1 ms<a delay requirement <=10 ms), since such traffic allows delay scheduling within a certain time range, only a few grant-free resources are reserved to support BSR reporting. Afterwards, the delay requirement can be met through dynamic scheduling of a network, which can effectively avoid excessive reservation of resources. In the above-mentioned example, as shown in FIG. 6A, periodic traffic and aperiodic burst traffic can also be distinguished. When differentiated resource reservation is performed based on the delay requirement, a policy of a data reservation grant-free resource pool can be adopted for the periodic delay critical UE group S1 and the aperiodic delay critical UE group S3, that is, for the group S1 and the group S3, resources required for traffic data transmission can be determined as reserved resources. A policy of an SR/BSR reservation grant-free resource pool can be adopted for the periodic delay critical UE group S2 and the aperiodic delay critical UE group S4, that is, for the group S2 and the group S4, resources corresponding to an SR and/or a BSR can be determined as reserved resources, and then dynamic resource scheduling is performed in real time when traffic transmission is performed on this basis.

In an embodiment of the disclosure, for a requirement level of traffic for a delay, a DATA reservation-based or data reservation superimposed dynamic scheduling grant (SR/BSR)-based differentiated grant-free resource reservation mechanism is adopted, so that excessive reservation of grant-free resources is reduced, and the system throughput is improved. As shown in Branch 1 of FIGS. 9A and 9B, an embodiment of the disclosure proposes a slice multiplexing scheme, where cross-slice resource reservation for delayed traffic transmission in an uplink network slice can be supported, and resources reserved for delay traffic in a slice can be reduced by implementing the differentiated reservation policy (as shown in FIG. 10A) in the embodiment of the disclosure. For extremely-low-delay traffic, the size of a reserved RB (resource block) matches a data packet size, so that a whole data packet can be transmitted at once. For low-delay (non-extremely-low-delay) traffic, it may be preferable to determine, based on an SR or a BSR, the size of the reserved RB to avoid excessive resource reservation. In the differentiated reservation policy, the delay requirement of the traffic is met by effectively reserving resources.

Optionally, as shown in FIGS. 6B to 6D, for common target traffic properties of each UE group, a target reservation policy match it can be selected from preset resource reservation policies.

In an embodiment of the disclosure, in order to guarantee the delay requirement in a case where resource utilization is high, traffic properties can be extracted and feature parsing is performed, and an accurate resource reservation policy is formulated for each traffic property. On the basis of obtaining a preset resource reservation policy, UEs can be grouped according to the traffic properties, and a corresponding target resource reservation policy is mapped for each UE group, as shown in FIG. 6B.

Optionally, when resource reservation is performed, the resource reservation can also be performed for both periodic traffic and aperiodic traffic. The operation of determining, for each UE group, corresponding reserved resource information includes at least one of:
for periodic traffic included in a first UE group and/or a third UE group, determining, based on a traffic transmission period, a first period, determining, based on a delay requirement for traffic, a second period, and determining, based on the first period and the second period, the reserved resource information respectively; and
determining, based on delay requirements for a second UE group and/or a fourth UE group, a third period, and determining, based on the third period, the reserved resource information.

For the UE group including the periodic traffic, the first period can be determined based on the transmission period of the traffic, the second period can be determined based on the delay requirement for traffic, and then reserved resource information is determined based on the first period and the second period respectively. For the UE group including the aperiodic traffic, the third period can be determined based on the delay requirement for the traffic within the UE group, and then the reserved resource information is determined based on the third period.

In an embodiment, as shown in FIG. 6C, a preset resource reservation policy adopted can be formulated for the above-mentioned traffic properties (which can be extracted from historical data of traffic transmission) such as PDB, MBDV and periodicity, including but not limited to the following preset resource reservation policies 1 to 4:
resource reservation policy 1: for periodic traffic with a PDB delay not greater than a preset third delay threshold value, a resource block RB is configured based on a data amount required for transmission within each period (a first period, a large period, determined based on a traffic transmission period of the periodic traffic); and for traffic with an extremely delay critical PDB, it is necessary to successfully transmit data packets at one time. Therefore, a maximum data amount required for successful transmission will be referred to when an RB is allocated. For the periodic traffic, a periodic resource is reserved for the traffic, and within each period (a second period determined based on a delay requirement), a robust resource is reserved according to a delay requirement (namely, a small period).

Resource reservation policy 2: For aperiodic traffic with a PDB delay not greater than a third delay threshold value, a third period during which resources need to be reserved is determined according to the delay requirement, and an RB is configured based on a data amount required for transmission with this period; and for traffic with an extremely delay critical PDB, it is necessary to successfully transmit data packets at one time. Therefore, a maximum data amount required for successful transmission will be referred to when an RB is allocated.

Resource reservation policy 3: For periodic traffic with a PDB delay greater than a third delay threshold value, an RB not greater than a preset threshold value is configured within each period (a first period, a large period, determined based on a traffic transmission period of the periodic traffic), and a dynamic scheduling resource is configured based on an SR and/or a BSR; and for traffic with a normally delay critical PDB, a data packet can be transmitted in a manner of combining resource reservation and dynamic scheduling. Firstly, a smaller RB resource is reserved, such that UE can immediately report its buffer size when the data packet arrives, and then all data is transmitted before a delay budget runs out in combination with dynamic scheduling. For the periodic traffic, a small number of RB resources are reserved periodically, and within each period (a second period determined based on a delay requirement), a robust resource is reserved according to the delay requirement (namely, a small period).

Resource reservation policy 4: for aperiodic traffic with a PDB delay greater than a third delay threshold value, a third period during which resources need to be reserved is determined according to a delay requirement, an RB not greater than a preset threshold value is configured within this period, and a dynamic scheduling resource is configured based on an SR and/or a BSR; and for traffic with a normally delay critical PDB, a data packet can be transmitted in a manner of combining resource reservation and dynamic scheduling. Firstly, a smaller RB resource is reserved, such that UE can immediately report its buffer size when the data packet arrives, and then all data is transmitted before a delay budget runs out in combination with dynamic scheduling. Optionally, when radio resources are limited, some UEs cannot reserve idle resources. Therefore, in the disclosure, a priority of a UE group can be defined according to a corresponding priority of delay critical traffic, and resource reservation is executed in priority order.

Based on feature parsing, an accurate resource reservation policy is formulated for different feature combinations. During resource allocation, it is preferable to allocate resources to a UE group with a relatively high delay requirement. In order, the resources are firstly allocated to UE groups adopting the resource reservation policy 1, and then reserved resources are allocated to groups using the resource reservation policies 2, 3 and 4. If there are no reserved resources available for allocation at this time, a way of high-priority dynamic scheduling is adopted for remaining terminals.

On the basis of the above-mentioned embodiments, considering the problem that poor spectral efficiency may be caused by reserving excessive dedicated resources due to the fact that an uplink scheduler does not know the time when traffic is generated, collaborative resources are also allocated by clustering traffic similarities and a channel correlation of the UEs within a CRS with an MU (multi-user) based multiplexing clustering algorithm (namely, an MU-based resource planning scheme, which is configured to be implemented in a long-time-scale environment), partitioning different UE groups, and generating a 3D resource grid involving a time domain, a frequency domain and a space domain in the embodiment of the disclosure. As shown in Branch 2 of FIGS. 9A and 9B, a candidate multiplexing resource grid is determined from a reserved resource collaborative space, and an optimal UE group is determined with maximizing spectral efficiency as a target to obtain high spectral efficiency.

When multiple UEs share a pre-allocated resource, it is possible that the multiple UEs perform transmission simultaneously on a same resource. A collision will introduce interference and reduce reliability. Therefore, in an embodiment of the disclosure, an MU-MIMO scheme is introduced into a system model, where MU-MIMO relies on a larger-scale antenna technology and a multi-user detection (MUD) technology to detect signals, and a base station (BS) decodes multiple signals from different UEs. MUD can improve the capacity of multiplexing and guarantees high reliability.

In an embodiment of the disclosure, an uplink MU-MIMO system is considered, where one BS can serve multiple UEs. The system can support multiple UEs Kₘₐₓ in a UE group, which forms an MU-MIMO system. In general, the BS determines UEs in the MU-MIMO through a PMI report of the UE or an estimation result of each UE of an SRS. Some policies are adopted to determine a UE pair in a group, such as highest channel isolation or a highest CQI after pairing, and the BS selects a pair of UEs with a highest coefficient from the UE group.

In one MU-MIMO system, a transmitting antenna Nₜ is equipped based on the size of the UE, and the BS is equipped with a receiving antenna Nᵣ. It is assumed that one MU-MIMO UE group has UE [symbol] ={k₁, k₂, . . . , k_{K}} served by one BS. For k^{th} UE, its estimated uplink fading channel is represented as Hₖ∈ [symbol] ^{N}^{ᵣ}^{×I}^{ₖ}, its transmitted signal is Hₖ∈ [symbol] ^{N}^{ᵣ}^{×I}^{ₖ}, Iₖ represents a transmission layer of the k^{th} UE, and accordingly, a received signal at the BS can be represented as y=h₁s₁+h₂s₂+ . . . +h_{K}S_{K}+Nₙ. Nₙ is a complex white Gaussian noise vector Nᵣ×1, and entries are distributed with a zero mean and variance σₙ².

Let a channel coefficient matrix be H=[h₁, h₂, . . . , h_{K}]∈ [symbol] ^{N}^{ᵣ}^{×L}^{ₖ}, and a transmitted signal vector be s=[s₁^{T}, s₂^{T}, . . . , s_{K}^{T}]^{T}∈ [symbol] ^{L}^{ₖ}^{×1}, where Lₖ=Σₖ₌₁^{K} Iₖ is the total number of transmitted data layers of the UE group. The received signal at the BS may be represented as y=Hs+Nₙ.

The uplink MU-MIMO has an MUD algorithm, such as ZF detection and MMSE detection. In an embodiment of the disclosure, the MMSE detection may be adopted as a baseline detector. The MMSE detection aims to minimize a mean square error between an actual transmitted symbol and an estimated value of the detector, while taking into account the influence of noise. It is intended to solve the technical problem of the examples of the disclosure to obtain a weight of an MMSE filter, such as

$$W = arg {min}_{W} E \{ {‖ Wy - s ‖}^{2} \} .$$

By using a principle of orthogonality, the weight of the MMSE filter is derived as W=(H^{H}H+σₙ²I_{L}_{ₖ}_{×L}_{ₖ})⁻¹H^{H}.

Wₖ∈ [symbol] ^{I}^{ₖ}^{×N}^{ᵣ} is set to represent a vector of the k^{th} UE of a weight matrix, and Wcan be represented as W=[w₁^{H}, w₂^{H}, . . . w_{K}^{H}]^{H}.

In an embodiment of the disclosure, SINR sorting selection is used in MMSE-SIC, and an SINR of the k^{th} UE is represented as

$${SINR}_{k} = \frac{{p}_{k} {‖ {w}_{k} {H}_{k} ‖}^{2}}{{‖ {w}_{k} {N}_{n} ‖}^{2} + {\sum }_{m = 1 , m \neq k}^{K} {p}_{m} {‖ {w}_{k} {H}_{m} ‖}^{2}} .$$

Pₖ is average power of the k^{th} UE. A detailed process of how to determine an optimal UE group and how to determine a corresponding resource grid will be explained below.

In a feasible embodiment, the operation of determining, for each UE group, corresponding reserved resource information respectively in operation S103 includes executing, for each UE group, at least one of the following steps A1 to A2:
operation A1: determine, based on a level of multiplexing in time domain, a level of multiplexing in frequency domain and/or a level of multiplexing in space domain, at least one UE set corresponding to the UE group, and determine reserved resource information for each UE set to process, based on the reserved resource information, traffic of each UE in a corresponding UE set.

In an embodiment of the disclosure, considering differences in traffic features, and differences between delay critical traffic in time-frequency-space domain, delay critical UE groups S can be classified based on the time, frequency and space domains, and partitioned into delay critical UE sets subS, and a grant-free resource pool is accordingly partitioned into resource pools corresponding to the UE sets. That is, a 3D resource grid can be obtained by partitioning a grant-free collaborative resource space.

In time domain, different pieces of traffic have different periods, and continuous reservation of grant-free resources will result in waste of resources and reduce the system throughput. Through traffic arrival properties (a traffic size, arrival time and the like), a level of aggregation in time domain, namely, a level of multiplexing in time domain, can be distinguished according to an overlap level of traffic transmitting times. In frequency domain, a level of aggregation in frequency domain, namely, a level of multiplexing in frequency domain, can be distinguished according to multiplexing in frequency domain. In space domain, a channel correlation will affect the number of MU multiplexing layers (a level of aggregation in space domain), namely, a level of multiplexing in space domain.

In an embodiment of the disclosure, UE with a high level of aggregation in time domain, a high level of aggregation in frequency domain, and a high level of aggregation in space domain may be considered to be classified into a same delay critical UE set subS.

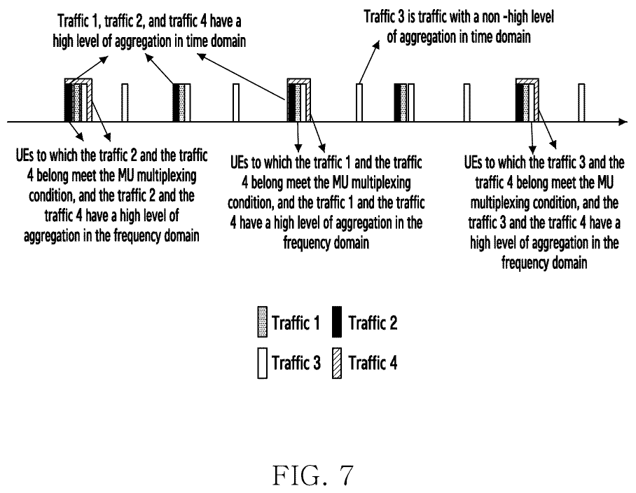

FIG. 7 is a schematic diagram of an overlap decision method for a time-frequency-space domain provided according to an embodiment of the disclosure.

Referring to FIG. 7, traffic 1, traffic 2 and traffic 4 are traffic with a high level of aggregation in time domain, and time domains 2/4, 1/4 and 3/4 can be each overlapped in frequency domain and multiplexed in space domain, and the traffic 1, traffic 3 and the traffic 4 do not overlap in time domain. Therefore, when set partitioning is performed, {1, 2, 4} can be partitioned into a same subS1 and the traffic 3 is partitioned into another subS2. Optionally, subS1 and subS2 allow overlap in time domain and frequency domain if space domain multiplexing requirements are met.

For an aperiodic reservation way, frequency domain and space domain resources can be reserved for aperiodic traffic according to historical statistical information, while time domain resources can be reserved continuously.

Optionally, the operation of determining, based on a level of multiplexing in time domain, a level of multiplexing in frequency domain and/or a level of multiplexing in space domain, at least one UE set corresponding to the UE group, and determining the reserved resource information for each UE set in step A1 includes the following operations A11 to A13:
step A11: determining, based on the level of multiplexing in time domain, the level of multiplexing in frequency domain and/or the level of multiplexing in space domain, candidate UE sets corresponding to the UE group.

Step A12: Determining first spectral efficiency corresponding to each candidate UE set.

Step A13: Determining, based on the first spectral efficiency, at least one UE set from the candidate UE sets, and determining the reserved resource information corresponding to each UE set.

A delay critical traffic set is partitioned into delay critical UE sets according to the level of aggregation in time domain, the level of aggregation in frequency domain and the level of aggregation in space domain. There may be multiple partitioning ways. The UE group is partitioned by adopting different partitioning ways, and partitioning results of multiple different UE sets can be obtained.

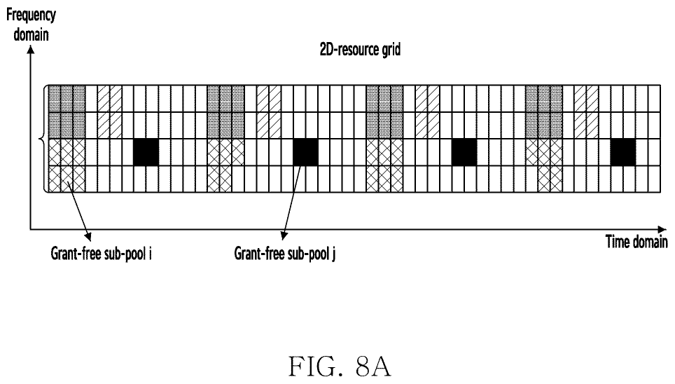

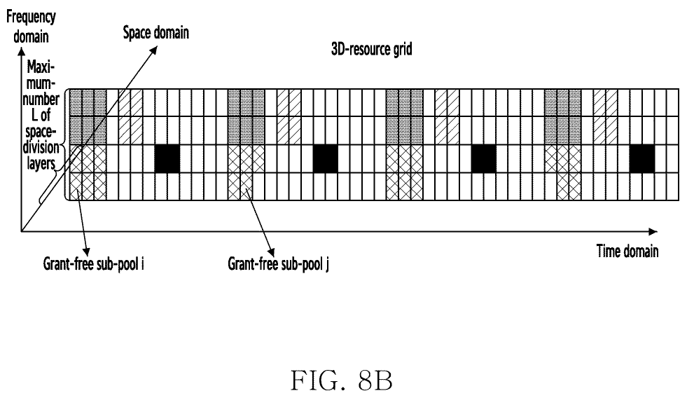

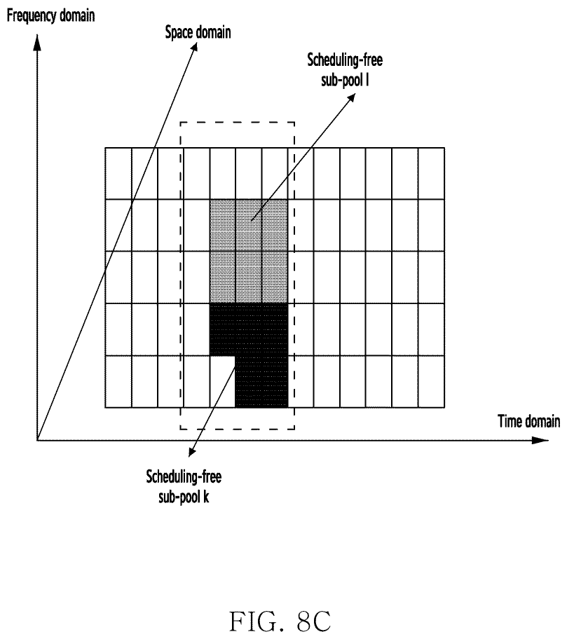

In an embodiment of the disclosure, taking maximizing overall spectral efficiency (first spectral efficiency) can be used as a target to determine a final partitioning result of the delay critical UE set and thus determine a grant-free resource grid (as shown in FIG. 8A).

The overall spectral efficiency is related to a frequency domain resource, a time domain resource and/or a space domain resource required by traffic, where the frequency domain resource is related to a traffic packet size, a delay, a channel condition and the like. The time domain resource is related to a traffic occurrence probability and a traffic duration requirement. The space domain resource is related to a traffic channel multiplexing requirement.

FIG. 8A is a schematic diagram of a 2D resource grid provided according to an embodiment of the disclosure.

FIG. 8B is a schematic diagram of a 3D resource grid provided according to an embodiment of the disclosure.

FIG. 8C is a schematic diagram of another 3D resource grid provided according to an embodiment of the disclosure.

For the delay critical UE set subS, the grant-free resource grid can be determined according to conditions, such as a UE channel state and a traffic distribution case in the set, as shown in FIG. 8A. Example explanation: if traffic A, traffic B and traffic C are partitioned into a same delay critical UE set subS, then the size (a size occupied by a grant-free sub-pool in the resource grid as shown in FIGS. 8A and 8B, where FIG. 8A shows a resource pattern determined based on a time-frequency domain, and FIG. 8B shows a resource pattern determined based on time-frequency-space domain) of a time-frequency-space domain resource can be determined by the following cases:
time domain: a time domain length is a set during which the occurrence probability of the traffic A, the traffic B, the traffic C is great than 0.

Frequency domain: A frequency domain length is maximum value max {RBa, RBb, RBc} of a frequency domain RB (resource block) required by the traffic A, the traffic B, the traffic C.

Space domain: A space domain length is a maximum number of pieces of traffic that can be space-division multiplexed for the time-frequency domain resource, determined by the channel conditions of each piece of traffic.

Reserved resource pattern information may be at a slice level or a UE level.

In an embodiment of the disclosure, based on a multiplexing probability of traffic and the capability of UE, an MU-based resource planning scheme is proposed, as shown in Branch 2 of FIG. 9A, to achieve high spectral efficiency.

A calculation process of overall spectral efficiency will be explained below with taking a UE set involved in some group as an example, and the calculation of the overall spectral efficiency can be performed by adopting one of the following calculation ways:

### Optional Calculation Way 1:

for a certain delay critical UE set, its required time-frequency-space domain resource can be obtained according to a channel condition, a traffic packet size and a multiplexing condition of delay critical traffic.

It is assumed that a time domain period length of an entire pool resource grid is T (the period length is a configurable parameter). The UEs in CRS 2 are grouped into different sets. The UEs with a high traffic similarity and a low channel correlation can perform multiplexing and co-transmission if they have traffic at the same time. Through a clustering algorithm, the UEs can be grouped into a same set Ø, and the number L_{Ø} of clustered multiplexing layers can be described as formula 1 below:

$${L}_{∅} = max \{ \vert A \vert \vert ( {P}_{i} ( t ) {P}_{j} ( t ) > 0 ) \&\& ( \frac{‖ {H}_{i} {H}_{j}^{H} ‖}{‖ {H}_{i} ‖ ‖ {H}_{j}^{H} ‖} \leq {TH}_{corr} ) \} ∀ i , 1 ∈ A , A ∈ ∅ , ∅ ∈ Ω , t ∈ T \qquad Formula 1$$

where L_{Ø} is the number of the multiplexing layers, A is a UE set which can be multiplexed, Pᵢ(t) is probability distribution of occurrence of traffic i for the UE, Pᵢ(t) is probability distribution of occurrence of traffic j for the UE, H is a channel matrix, and TH_{corr} is a correlation threshold of a multi-UE multiplexing channel.

Resources are planned for the CRS, and a resource grid (as shown in FIG. 7) corresponding to a UE set obtained by partitioning the CRS group shown in FIG. 10A can be represented by a 3D coordinate of a time-frequency-space domain. A resource planning scheme taking maximum spectral efficiency as a target can be described with an objective function as shown in formula 2 below:

$$Θ = arg max ( \frac{{\sum }_{m} {Θ}_{m} * {BW}_{m} * {T}_{m}}{{\sum }_{m} {BW}_{m} * {T}_{m}} ) \qquad Formula 2$$

where Θₘ is obtained by formula 3 below:

$${Θ}_{m} = \frac{{\sum }_{i = 1}^{n} ( {D}_{mi} )}{{BW}_{m} * {T}_{m}} \qquad Formula 3$$

In the above-mentioned formulas 2 and 3, Θₘ, Tₘ and BWₘ are respectively spectral efficiency, traffic generation duration and a maximum bandwidth requirement of a delay critical UE set Øₘ within time T. It is assumed that a traffic duration Tₘᵢ={Tᵢ|Prob(t)>0} corresponding to the traffic i in the delay critical UE set Øₘ represents a time length during which a probability of transmitting a traffic packet corresponding to the traffic i is greater than 0, or a time length during which a predicted BO is greater than 0; and Tₘ is a union in which all traffic i in the set with a probability of occurrence greater than 0. Dₘᵢ is the size of a traffic packet or BSR of UEₘᵢ in the delay critical UE set Øₘ.

In combination with Shannon formula C=Blog (1+S/N), and in consideration of a possibility of uplink MU multiplexing, the number Lm of UE multiplexing layers in the delay critical UE set can be determined according to a UE channel correlation in the delay critical UE set. SINRₘᵢ is an average SINR of UEₘᵢ in the delay critical UE set Øm, which is a filter value of a historical SINR reported based on a radio access device, and represents an average channel condition. According to empirical or historical statistical information, a decrease level Om in SINR can be estimated in advance, a demand for frequency domain resources by the delay critical UE set Øₘ can be deduced, as shown in formula 4 below:

$${BW}_{m} = max ( \frac{{D}_{mi}}{{log}_{2} ( 1 + {SINR}_{mi} / {δ}_{m} )} ) \qquad Formula 4$$

In an embodiment of the disclosure, an optimal solution for the partitioning of the delay critical UE set is sought by a mathematical method with maximization of Θ spectral efficiency as an objective function, namely, obtaining reserved resource grid information. The resource grid information may be marked with {Tₘ, BWₘ, Lₘ}, in a 3D coordinate system. A heuristic algorithm or AI-based algorithm may each be used for solve this problem, and the algorithms adopted are not limited by the embodiments of the disclosure. In an embodiment of the disclosure, collaborative resources of a space can be reduced, and the spectral efficiency can be improved through resource planning.

### Optional Calculation Way 2:

for a certain delay critical UE set, its required time-frequency-space domain resource can be obtained according to a channel condition, a traffic packet size and a multiplexing condition of delay critical traffic. Firstly, optimal UE partitioning is performed with a maximum sum of data transmission rates obtained after grouping of one CRS as an objective function, and then 3D resource grid planning in time-frequency-space domains is performed on the basis of an optimal UE set with allocating the least RBs for a UE set obtained after the partitioning as a target to maximize overall spectral efficiency.

In a feasible embodiment, in order to improve resource utilization and simultaneous transmission reliability, a scheme where probabilistic multiplexing and UE set partitioning is performed, based on a simultaneous transmission probability and multi-UE interference information, on UEs in a same UE group is further provided.

Step A2: Determine, based on a simultaneous transmission probability and/or interference information between the UEs, at least one UE set corresponding to the UE group, and determine reserved resource information for each UE set to process, based on the reserved resource information, traffic of each UE in a corresponding UE set.

Optionally, for a same UE group, the UE group may be partitioned according to the simultaneous transmission probability and the interference between multiplexed UE to obtain several UE sets to implement a probabilistic multiplexing gain. The probabilistic multiplexing gain may be defined as an increase in a data transmission rate after probabilistic multiplexing by the UE.

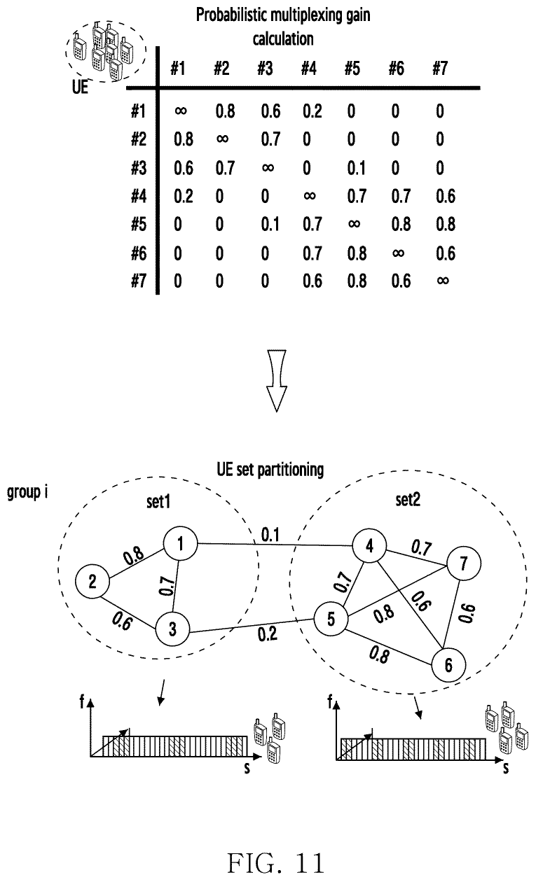

FIG. 11 is a schematic diagram for partitioning a UE group provided according to an embodiment of the disclosure.

Optionally, as shown in FIG. 11, the operation of determining, based on a simultaneous transmission probability and/or interference information between the UEs, at least one UE set corresponding to the UE group in step A2 includes operations of the following steps A21 to A24:

step A21: determine a simultaneous transmission probability of at least two UEs in the UE group.

The traffic of a same UE group is approximately independent identically distributed (IID), and for the at least two UEs in the UE group, the simultaneous transmission probabilities (also referred to as a synchronous transmission probabilities) of the at least two UEs on each slot can be determined based on preset traffic.

Optionally, the synchronous transmission probability Pᵢⱼ(t) is calculated by formula 5 below:

$${P}_{ij} ( t ) = {P}_{i} ( t ) {P}_{j} ( t ) \qquad Formula 5$$

where Pᵢ(t) and Pᵢ(t) are transmission probabilities of UE i and UE j in a same UE group on each slot t.

Delay critical traffic is modeled as periodic traffic and aperiodic traffic. In order to obtain the synchronous transmission probability Pᵢⱼ(t), in an embodiment of the disclosure a traffic model for the periodic traffic and the aperiodic traffic can be established according to historical statistical data of scheduling request receiving times.

Optionally, the operation of determining, based on predicted traffic distribution, the simultaneous transmission probability of the at least two UEs includes one of:
predicting first traffic distribution of periodic traffic, and determining, based on the first traffic distribution, a first transmission probability of the at least two UEs simultaneously on each slot; and
predicting second traffic distribution for aperiodic traffic, and determining, based on the second traffic distribution, a second transmission probability of the at least two UEs simultaneously on each slot.

It is assumed that the number of data packets generated by the aperiodic traffic per second on average is λ, the number of slots per second is ΔT, the number of data packets generated on each slot is

$${λ}^{′} = \frac{λ}{Δ T} ,$$

ΔT is the number of the slots per second, and a probability that aperiodic UE generate data packets on the slot is

$$P = 1 - {{e}^{-}}^{\frac{λ}{Δ T}} .$$

If a delay required by a delay critical PDB is ρ, and the sum of CN PDB and gNB processing delays is ε, then a delay of an air interface will be τ=ρ−ε. In order to guarantee that an aperiodic data packet can be transmit within a minimum time after being generated, a resource interval reserved for aperiodic delay critical traffic is a PDB air interface requirement. Therefore, the transmission probability distribution of data on each slot is as shown in formula 6-1 below:

$$P ( t ) = \{ \begin{matrix}0 & ( n - 1 ) τ \cdot {t}_{s} < t < n τ \cdot {t}_{s} \\ 1 - {e}^{- {τλ}^{′}} & t = n τ \cdot {t}_{s}\end{matrix} \qquad Formula 6 - 1$$

where n is an n^{th} resource reserved.

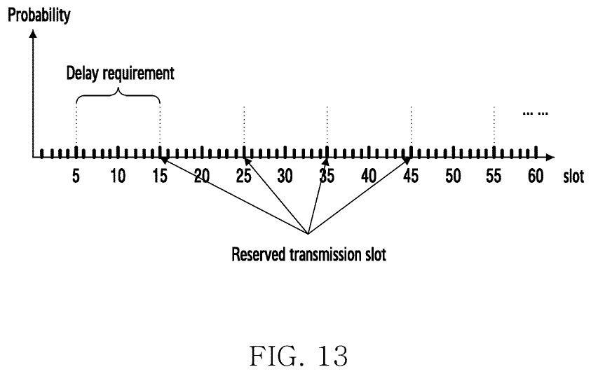

FIG. 13 shows a schematic diagram of performing resource reservation for aperiodic traffic according to an embodiment of the disclosure.

Optionally, as shown in FIG. 13, when a probabilistic traffic model for the aperiodic traffic is constructed, for aperiodic traffic, sufficient slots need to be reserved in consideration of a delay requirement. Traffic distribution of the aperiodic traffic usually follows Poisson distribution:

$$P ( x = k ) = \frac{{( {λ}^{′} )}^{k}}{k !} * {e}^{- {λ}^{′}} , k = 0 , 1 , 2 , … ,$$

where λ′ is the number of data packets generated per millisecond on average, λ′=[λ/(1000*tₛ)]. On this basis, the transmission probability Pᵢ(t) of the UEi of the aperiodic traffic on each slot is as shown in formula 6-2 below:

$$P ( t ) = \{ \begin{matrix}1 - {e}^{- τλ} & t = m τ {t}_{s} \\ 0 & Others\end{matrix} \qquad Formula 6 - 2$$

Calculation of transmission probability of periodic traffic: It is assumed that the periodic traffic obeys normal distribution before and after each periodic data packet is generated, and this assumption is due to the particularity of an uplink. Even for the periodic traffic, it is difficult for gNB to predict a slot position where a UE data packet is specifically generated. The slot where the gNB receives the UE data packet for the first time is denoted as s, and a data packet period can be set as T, then an n^{th} periodic data packet generates μ=s+nT, a probability density function is

$$f ( t ) = \frac{1}{\sqrt{2 π} σ} {e}^{- \frac{{( t - μ )}^{2}}{2 {σ}^{2}}} ,$$

and a time interval reserved for the UE data packet in each period refers to the PDB air interface requirement. Therefore, periodic transmission probability distribution of traffic generated by the UE on [—τ₀, τ₀] in each period can be as shown in formula 6-3 below:

$$P ( t ) = \{ \begin{matrix}0 & - {τ}_{0} + ( n - 1 ) τ {t}_{s} < t < - {τ}_{0} + n τ {t}_{s} \\ {\int }_{- {τ}_{0} + ( n - 1 ) τ {t}_{s}}^{- {τ}_{0} + n τ {t}_{s}} f ( t ) dt & t = - {τ}_{0} + n τ \cdot {t}_{s}\end{matrix} \qquad Formula 6 - 3$$

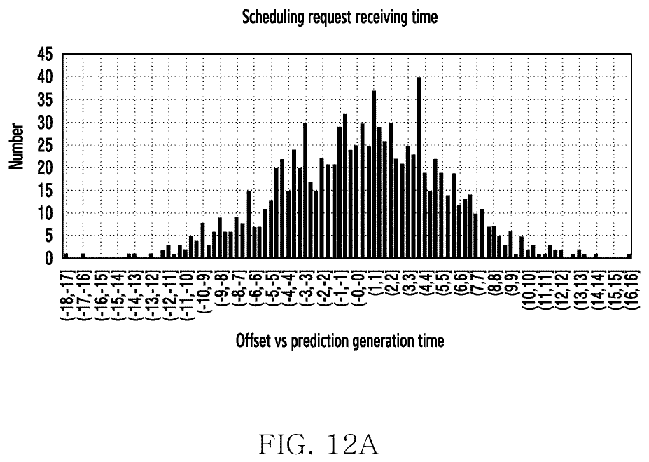

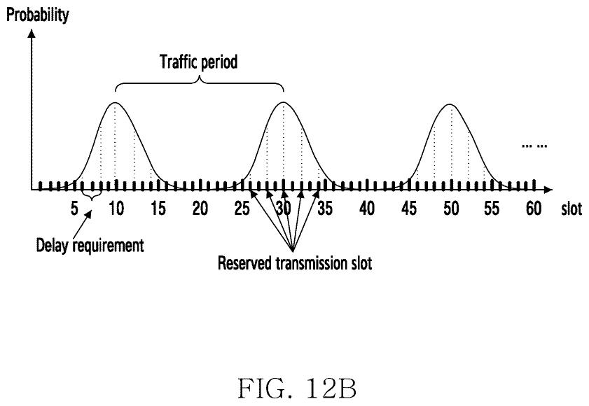

FIG. 12A is a schematic diagram of normal distribution of scheduling request receiving times provided according to an embodiment of the disclosure.

FIG. 12B shows a schematic diagram of performing resource reservation for periodic traffic according to an embodiment of the disclosure.

Optionally, in the calculation of the transmission probability of the periodic traffic, additional slots are reserved in each period according to the delay requirement in consideration of periodicity and the robust reservation. Referring to FIGS. 12A and 12B, according to analysis of test data, scheduling request receiving times obey normal distribution in each time period. Therefore, data generation distribution in each time period can be obtained as follows:

$$f ( t ) = \frac{1}{\sqrt{2 π} σ} {e}^{- \frac{{( t - μ )}^{2}}{2 {σ}^{2}}} , μ = nT ,$$

where T is an arrival period of a data packet, σ is an arrival variance of the data packet, and n is the number of the data packets. On this basis, the transmission probability Pᵢ(t) of the UEi with the periodic traffic on each slot is as shown in formula 6-4 below:

$$P ( t ) = \{ \begin{matrix}{\int }_{- {τ}_{0} + ( n - 1 ) τ {t}_{s}}^{- {τ}_{0} + n τ {t}_{s}} f ( t ) dt & t = - {τ}_{0} + m τ {t}_{s} \\ 0 & Others\end{matrix} \qquad Formula 6 - 4$$

Parameter values involved in the modeling of the above-mentioned periodic traffic and aperiodic traffic can be selected by adopting one of the following ways:

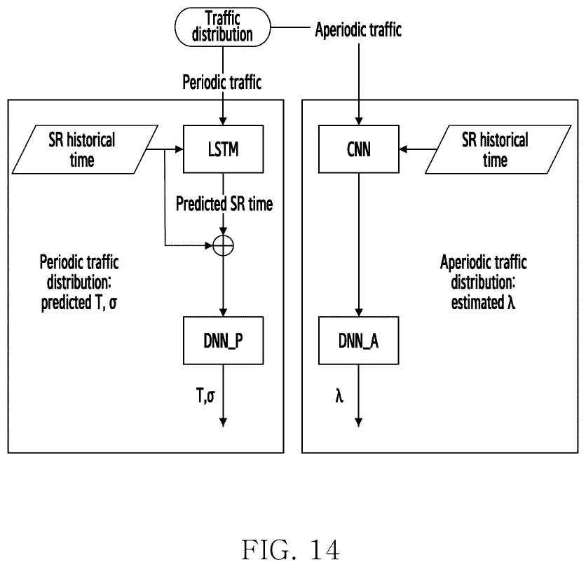

FIG. 14 is a schematic diagram of predicting UE data packet distribution via AI provided according to an embodiment of the disclosure.

### Alternative 1: (AI Method,)

Referring to FIG. 14, in order to obtain a transmission model, firstly, it is necessary to obtain a generation period T and an arrival variance σ of the periodic traffic and the number λ of messages arriving per second on average of the aperiodic traffic. Historical information of scheduling request (SR) receiving times and traffic type information are learned via an LSTM module and a DNN module of AI, the period T and the arrival variance σ of the periodic traffic can be obtained. The historical information of the scheduling request (SR) receiving times and the traffic type information are learned via a CNN module and the DNN module of the AI, the number λ of messages arriving per second on average of the aperiodic traffic can be obtained.

When predicating first traffic distribution of the periodic traffic, next scheduling information can be predicted by a pre-constructed first neural network, for a UE group, based on historical scheduling information, and the first traffic distribution of the periodic traffic can be predicted by a pre-constructed second neural network, based on the historical scheduling information, the next scheduling information, traffic type information and traffic period information.

Optionally, the first neural network may adopt an LSTM (Long Short-Term Memory) module, where this module is configured to predict, based on a historical scheduling request (SR) message, a next scheduling request (SR) message; the second neural network may adopt a DNN_P (Deep Neural Networks for periodic traffic) module, where this module is configured to determine, based on the historical scheduling request (SR) message, a predicted scheduling request (SR) message, a traffic type and a traffic period, the period T and the arrival variance σ. The historical scheduling request (SR) message represents times of receiving the historical scheduling request (SR) message of periodic delay critical traffic, and interval distribution. The predicted scheduling request (SR) message represents the arrival time of the next scheduling request (SR) message, and the traffic type represents 5QI-related information or traffic. After parameters of corresponding periodic traffic are obtained, the first traffic distribution can be obtained by calculation based on the above-mentioned formula 6-3, and then for each UE in the UE group, the first transmission probability on each slot is obtained by calculation based on the above-mentioned formula 6-4. Then, the simultaneous transmission probability of the at least two UEs in the UE group is calculated by the above-mentioned formula 5.

When predicating the second traffic distribution of the aperiodic traffic, traffic features can be extracted for the UE group through a pre-constructed third neural network, and the second traffic distribution of the aperiodic traffic can be predicted through a pre-constructed fourth neural network based on the traffic features.

Optionally, the third neural network may adopt a CNN (Convolutional Neural Network) module, where this module can extract the traffic features, such as traffic arrival time features, from the historical scheduling information. The traffic arrival time features include an average interval, a variance, a maximum value, a gradient and a probability of traffic arrival. The traffic arrival time feature represents times of receiving a historical scheduling request (SR) and interval distribution of aperiodic delay critical traffic. The fourth neural network may adopt a DNN_A (Deep Neural Networks for aperiodic traffic) module, where this module may be configured to determine, based on the traffic arrival time features, a parameter A, where A represents the number of the messages arriving per second on average. After parameters of corresponding aperiodic traffic are obtained, the second traffic distribution can be obtained by calculation based on the above-mentioned formula 6-1, and then for each UE in the UE group, the second transmission probability on each slot is obtained by calculation based on the above-mentioned formula 6-2. Then, the simultaneous transmission probability of the at least two UEs in the UE group is calculated by the above-mentioned formula 5.

### Alternative II:

For periodic traffic, first traffic distribution of the periodic traffic can be predicted based on historical scheduling information, for a UE group. Optionally, traffic probability distribution is fitted by maximum likelihood estimation, and related parameters are obtained. For the periodic traffic, a set of historical scheduling request (SR) messages {PRT₁, PRT₂, . . . , PRTₙ} of the periodic traffic are given, a traffic generation period T is solved according to a minimized objective function

$$\frac{1}{n} {\sum }_{i = 1}^{n} \vert iT - {PRT}_{i} \vert ,$$

and then, a traffic arrival expectation μ and a variance σ,

$$μ = nT , σ = \sqrt{\frac{1}{n} {\sum }_{i = 1}^{n} {( {PRT}_{i} - iT )}^{2}}$$

are obtained. After parameters of corresponding periodic traffic are obtained, the first traffic distribution can be obtained by calculation based on the above-mentioned formula 6-3, and then for each UE in the UE group, the first transmission probability on each slot is obtained by calculation based on the above-mentioned formula 6-4. Then, the simultaneous transmission probability of the at least two UEs in the UE group is calculated by the above-mentioned formula 5.

For aperiodic traffic, second traffic distribution of the aperiodic traffic is predicted based on historical scheduling information, for the UE group. It is assumed that n historical scheduling request (SR) messages are obtained within a duration of t slots, and

$$λ = \frac{n}{t}$$

can be obtained according to a Poisson distribution hypothesis of conventional aperiodic traffic. Then, after parameters of corresponding aperiodic traffic are obtained, the second traffic distribution can be obtained by calculation based on the above-mentioned formula 6-1, and then for each UE in the UE group, the second transmission probability on each slot is obtained by calculation based on the above-mentioned formula 6-2. Then, the simultaneous transmission probability of the at least two UEs in the UE group is calculated by the above-mentioned formula 5.

After a DCRS classification decision, delay critical traffic of all UEs in a CRS is independent identically distributed. Therefore, a probability of at least two UEs, UEi and UEj, performing transmission on a same slot is: Pᵢⱼ(t)=Pᵢ(t)Pⱼ(t). UE i, UEj∈ [symbol] , where [symbol] is a UE set in a [symbol] ^{th} CRS.

For UEs that may perform transmission simultaneously, MU-MIMO multiplexing transmission is considered to improve spectral efficiency of a system.

Step A22: Determine interference information between the at least two UEs in the UE group (calculate interference between multiple UEs).

Selection of MMSE (Min mean square error) channel detection method, and calculation of interference between UEs: I_{MU}(i, j)=|wᵢhⱼ|² is the interference of UE i from UE j, wᵢ represents a weight matrix vector of UE i, hⱼ represents an uplink fading channel estimated by UE j, and pⱼ is average power of UE j. Multi-UE interference of UEi can be represented as formula 7:

$${I}_{MU} ( {A}_{k} ) = {\sum }_{j = 1 , j \neq i}^{\vert {A}_{k} \vert} {\vert {w}_{i} {h}_{j} \vert}^{2} = {\sum }_{j = 1 , j \neq i}^{\vert {A}_{k} \vert} {I}_{MU} ( i , j ) \qquad Formula 7$$

where |Aₖ| represents the number of elements in an Aₖ set.

Step A23: Determine, based on the simultaneous transmission probability and/or the interference information, a probabilistic multiplexing gain of the at least two UEs in the UE group.

Since the UE shares a same reserved resource in a probabilistic manner, the multi-UE interference and the simultaneous transmission probability of the multiple UEs are considered when the multiplexing gain is estimated.

Optionally, the operation of determining, based on the simultaneous transmission probability and/or the interference information, a probabilistic multiplexing gain of the at least two UEs in the UE group includes:
determining a multiplexing gain of the at least two UEs in the UE group; and
determining, based on the simultaneous transmission probability and the multiplexing gain, the probabilistic multiplexing gain of the at least two UEs in the UE group.

Optionally, from I_{MU}(Aₖ), for a given multi-UE set, if the interference between any UE pair is relatively small, an SINR of each UE in the multi-UE set is relatively large. For a given multi-UE set, if the SINR of each UE is relatively large, the multiplexing gain of the multi-UE set is better. The calculation of the multiplexing gain for any number of UE combinations is transferred to the calculation of the multiplexing gain of any UE pair.

In a case of multiple UEs, when there is interference between the multiple UEs, spectral efficiency after resource multiplexing by the at least two UEs is determined. Optionally, the spectral efficiency of UE i is

$${η}_{i} ( t ) = {log}_{2} ( 1 + \frac{{p}_{i} {\vert {w}_{i} {h}_{i} \vert}^{2}}{{\sum }_{j = 1 , j \neq i}^{ζ ( t )} {P}_{j} ( t ) {\vert {w}_{i} {h}_{j} \vert}^{2} + {\vert {w}_{i} σ \vert}^{2}} ) ,$$

where Pⱼ(t) is a probability of UEj performing transmission on slot t, and ζ(t) is the total number of possible UEs on slot t, ζ(t)≤card (Aₖ).

If there is no interference between the UEs, spectral efficiency before resource multiplexing by the at least two UEs is determined. Optionally, the spectral efficiency of UEi is

$${η}_{i}^{′} ( t ) = {log}_{2} ( 1 + \frac{{p}_{i} {\vert w {′}_{i} {h}_{i} \vert}^{2}}{{\vert w {′}_{i} σ \vert}^{2}} ) .$$

Therefore, the multiplexing gain of the at least two UEs can be determined based on the spectral efficiency after the resource multiplexing and the spectral efficiency before the resource multiplexing. Optionally, for each UE (i, j) pair, the multiplexing gain can be as shown in formula 8:

$${g}_{ij} ( t ) = 2 \frac{{η}_{i} ( t ) + {η}_{j} ( t )}{{η}_{i}^{′} ( t ) + {η}_{j}^{′} ( t )} \qquad Formula 8$$

In consideration of the transmission probability, the probabilistic multiplexing gain is as shown in formula 9 below:

$${g}_{ij} ( t ) = 2 {P}_{ij} ( t ) \frac{{η}_{i} ( t ) + {η}_{j} ( t )}{{η}_{i}^{′} ( t ) + {η}_{j}^{′} ( t )} \qquad Formula 9$$

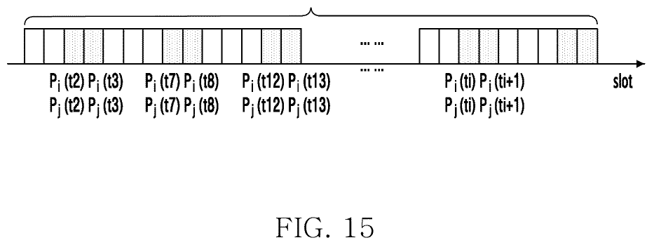

FIG. 15 is a schematic diagram of determining a probabilistic multiplexing gain provided according to an embodiment of the disclosure.

Referring to FIG. 15, where Pᵢⱼ(t) is a probability of UEi and UEj performing transmission simultaneously on slot t, ηᵢ′(t) and ηⱼ′(t) represent rates of UEi and UEj per unit bandwidth before multiplexing, respectively, and ηᵢ(t) and ηⱼ(t) represent rates of UEi and UEj per unit bandwidth after multiplexing, respectively. Within an assessed duration T′, UE (i, j) performs multiplexing on same time domain and frequency domain resources with a certain probability.

Therefore, an MU coefficient of a probability of a UE (i, j) pair within an estimated duration T′ is as shown in formula 10:

$${𝓍}_{ij} = {\sum }_{t = 0}^{{T}^{′}} {g}_{ij}^{′} ( t ) \qquad Formula 10$$

Accordingly, an MU coefficient matrix X of the probability in a same group CRS ωₗ is as shown in formula 11:

$$𝒳 = [ \begin{matrix}{𝓍}_{11} & … & {𝓍}_{1 n} \\ ⋮ & ⋱ & ⋮ \\ {𝓍}_{n 1} & … & {𝓍}_{nn}\end{matrix} ] \qquad Formula 11$$

Step A24: Determine, based on the probabilistic multiplexing gain, at least one UE set corresponding to the UE group.

To seek an optimal set partitioning scheme, the MU coefficient matrix X of the probability is designed in the disclosure. Since the gains of multiple UEs is different in different UE combinations, it will be inefficient to traverse all possible combinations in one CRS. In consideration of computational overhead, a large combinatorial operation is converted into a simple and efficient operation. An optimal set partitioning objective function will be constructed and then solved by an efficient method. The purpose of constructing the optimal set partitioning objective function is: if the multiplexing gain between any UE pairs in a same UE set is higher, then a total multiplexing gain of the UE set is higher than that of a UE set with a poor multiplexing gain between the UEs pairs.

The content of constructing the set partitioning objective function (partitioning an undirected graph) will be explained below.

In an uplink MU-MIMO system, the transmission data rate of i^{th} UE within a t^{th} slot can be represented as formula 12 below:

$${η}_{i} ( t ) = {log}_{2} ( 1 + \frac{{δ}_{i} {\vert {w}_{i} {h}_{i} \vert}^{2}}{{\sum }_{j = 1 , j \neq i}^{ζ} {P}_{j} ( t ) {\vert {w}_{i} {h}_{j} \vert}^{2} + {\vert {w}_{i} σ \vert}^{2}} ) \qquad Formula 12$$

where ζ is the number of all possible UEs in the slot t, ζ≤|Aₖ|, δᵢ is average power of UEi, wᵢ is a weight matrix vector of the i^{th} UE, hᵢ is a channel estimation matrix vector of the UEi, Pⱼ(t) represents a transmission probability of the UEj on the slot t, and σ is a Gaussian white noise interference vector. The data transmission rate of the UE on each slot can be calculated by formula 12.

The sum of rates of a UE set Aₖ over a long time period θ can be represented as formula 13 below:

$$η ( {A}_{k} ) = {\sum }_{t = 0}^{θ} {\sum }_{i = 1}^{ζ ( t )} {P}_{i} ( t ) {η}_{i} ( t ) \qquad Formula 13$$

Based on formula 13, the sum of the data transmission rates of a UE included in each clustering result in a period corresponding to each slot can be determined based on the data transmission rate and the transmission probability of the UE on each slot, and when a partitioning operation of the undirected graph is subsequently performed, partitioning can be performed based on the sum of the data transmission rates to obtain at least one sub-graph.

The sum of data transmission rates after grouping of one CRS we is maximized, and an optimal objective function is as shown in formula 14:

$$\underbrace{argmax}_{𝒜 = \{ {A}_{1} , {A}_{2} , … , {A}_{k} \}} ( {\sum }_{k = 1}^{K} η ( {A}_{k} ) ) \qquad Formula 14$$

where [symbol] ={A₁, A₂, . . . , Aₖ} is a UE grouping set. Constraint conditions are as follows: ∪ₖ₌₁^{K} Aₖ= [symbol] and ∩ₖ₌₁^{K} Aₖ=Ø.

The content of solving the optimal set partitioning objective function will be explained below.

Optionally, the operation of determining, based on the probabilistic multiplexing gain, at least one UE set corresponding to the UE group includes:
constructing, based on a probabilistic multiplexing gain of at least two UEs in the UE group, an undirected graph of the UE group, where a node in the undirected graph corresponds to a UE in the UE group, and an undirected edge connected between the nodes corresponds to the probabilistic multiplexing gain of the corresponding two UEs; and
partitioning the undirected graph by clustering the UEs in the UE group to obtain at least one sub-graph, where the at least one sub-graph corresponds to at least one UE set in the UE group, and a probability of successful multiplexing of at least two UEs in each UE set is greater than that of successful multiplexing of at least two UEs between the UE sets.

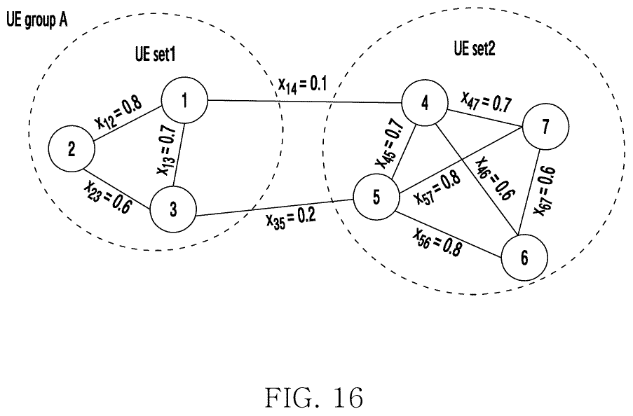

FIG. 16 shows a schematic diagram of partitioning a UE group to obtain several UE sets according to an embodiment of the disclosure.

Referring to FIG. 16, the above-mentioned optimal set partitioning objective function can be converted into a graph partitioning problem, and then is solved by adopting a common clustering algorithm such as k-means and kmeans++. After set partitioning, an average gain of the UE sets should be as large as possible, and an average gain between different UE sets should be as small as possible.

In an embodiment of the disclosure, UEs are partitioned based on an MU multiplexing factor between every two UEs into several sets, which aims to partition the UEs with a relatively low probability of successful multiplexing into different sets, partition the UEs with a relatively high probability of successful multiplexing into a same set as well, and finally obtain a set with a highest sum of average rates of successful multiplexing of the UEs in each set. In an embodiment of the disclosure, a graph theory-based low-complexity set partitioning method is adopted. Firstly, a UE partitioning problem is converted into a multi-path partitioning problem of an undirected graph G=(V, E), and a MU multiplexing factor matrix is used as an adjacency matrix of the graph to construct a normalized Laplacian matrix, and then to find and normalize its feature vectors to achieve the purpose of dimension reduction for the partitioning problem. Next, a set clustering operation is performed on the normalized feature vectors to find an optimal set.

The multi-path partitioning problem of undirected graph can be implemented by adopting the following graph splitting methods.

From formula 14, it is necessary to find [symbol] ={A₁, A₂, . . . , Aₖ} to achieve an optimal PMU gain.

In the first step, an undirected weight graph is constructed based on the MU multiplexing factor matrix.

For the undirected graph G=(V, E), V={UE₁, UE₂, . . . , UEₙ} is a sample set of all n UEs, forming a vertex set of the undirected graph. For any two points in V, they may be connected with edges or may be connected without edges. n=card (Aₖ). E={xᵢⱼ} is a set of edge weights between the vertices of the undirected graph, where Xᵢⱼ represents the MU multiplexing factor between UEᵢ and UEⱼ obtained above, and Xᵢⱼ=Xⱼᵢ. In a model of the disclosure, X=[xᵢⱼ]_{n×n} is taken as the adjacency matrix of the undirected graph. Therefore, a degree matrix is [symbol] =[dᵢⱼ]_{n×n}, where dᵢᵢ=Σⱼ₌₁ⁿxᵢⱼ;dᵢⱼ=0.

In the second step, an objective function of a graph splitting problem is determined.

The multi-path partitioning of the undirected graph G=(V, E) can be represented as Cut(A₁, A₂, . . . , Aₖ_{₁}), where Aᵢ∩Aⱼ=ϕ and A₁ ∪A₂ ∪ . . . ∪Aₖ=V. In an embodiment of the disclosure, the Laplacian matrix is defined as L=D-X, and an indicator vector hₖ∈{h₁, h₂, . . . , h_{K}} is introduced.

$$wherein {h}_{ik} = \{ \begin{matrix}0 & {UE}_{i} ∉ {A}_{k} \\ \frac{1}{\sqrt{vol ( {A}_{k} )}} & {UE}_{i} ∈ {A}_{K}\end{matrix} , and \\ wherein i ∈ \{ 1 , 2 , ⋯ , n \} , k ∈ \{ 1 , 2 , ⋯ , K \} , K < n .$$

For an indicator vector hᵢ∈ [symbol] ⁿ and an indicator matrix H=[hᵢⱼ]_{n×k}_{₁}, according to properties of the Laplacian matrix, the following calculation results can be obtained:

$$\begin{matrix}{h}_{k}^{T} {Lh}_{k} = \frac{1}{2} {\sum }_{i = 1}^{n} {\sum }_{j = 1}^{n} {{x}_{ij} ( {h}_{ki} - {h}_{kj} )}^{2} \\ = \frac{1}{2} ( {\sum }_{i ∈ {A}_{k} , j ∉ {A}_{k}} {{x}_{ij} ( \frac{1}{\sqrt{vol ( {A}_{k} )}} - 1 )}^{2} + {\sum }_{i ∉ {A}_{k} , j ∈ {A}_{k}} {{x}_{ij} ( 0 - \frac{1}{\sqrt{vol ( {A}_{k} )}} )}^{2} ) \\ = \frac{1}{2} ( {\sum }_{i ∈ {A}_{k} , j ∉ {A}_{k}} \frac{{x}_{ij}}{vol ( {A}_{k} )} + {\sum }_{i ∉ {A}_{k} , j ∈ {A}_{k}} \frac{{x}_{ij}}{vol ( {A}_{k} )} ) \\ = \frac{1}{2} ( \frac{cut ( {A}_{k} , {\overline{A}}_{k} )}{vol ( {A}_{k} )} + \frac{cut ( {\overline{A}}_{k} , {A}_{k} )}{vol ( {A}_{k} )} ) \\ = \frac{cut ( {A}_{k} , {\overline{A}}_{k} )}{vol ( {A}_{k} )}\end{matrix}$$

where Aₖ⊆V, Āₖ is a join complement of Aₖ, and vol(Aₖ)=Σ_{j∈A}_{_{K}} dⱼ.

Therefore, the multi-path partitioning problem of the undirected graph can be described as formula 15 below:

$$Cut ( {A}_{1} , {A}_{2} , ⋯ , {A}_{K} ) = {\sum }_{k = 1}^{n} {h}_{k}^{T} {Lh}_{k} = {\sum }_{k = 1}^{n} {( {ℋ}^{T} ℒℋ )}_{kk} = tr ( {ℋ}^{T} ℒℋ ) \qquad Formula 15$$

In addition,

$${h}_{k}^{T} {Dh}_{k} = {\sum }_{j = 1}^{n} {h}_{kj}^{2} {d}_{j} = \frac{1}{vol ( {A}_{k} )} {\sum }_{j ∈ {A}_{k}} {d}_{j} = 1.$$

Therefore [symbol] =I.

$$ℋ = {𝒟}^{- \frac{1}{2}} ℱ$$

is set, then

$${ℋ}^{T} ℒℋ = {ℱ}^{T} {𝒟}^{- \frac{1}{2}} L {𝒟}^{- \frac{1}{2}} ℱ ,$$

and [symbol] = [symbol] =I.

Assuming that F is a feature matrix composed of first k feature vectors of a normalized d Laplacian matrix L, the graph splitting problem can be described as formula 16 below:

$$\underbrace{argmax}_{F} tr ( {F}^{T} {D}^{- \frac{1}{2}} {LD}^{- \frac{1}{2}} F ) \\ s . t . {F}^{T} F = I \qquad Formula 16$$

In the third step, a problem of optimization is solved.

k minimum feature values of a normalized Laplacian matrix

$${L}_{sym} = {D}^{- \frac{1}{2}} {LD}^{- \frac{1}{2}}$$

and their corresponding feature vectors are calculated, and these feature vectors are taken as column vectors of the matrix and normalized by rows to obtain a matrix F_{n×k}. Let yᵢ(i∈{1, 2, . . . , n}) represent an i^{th} row vector of a matrix F. A sample set {y₁, y₂, . . . , yₙ} is partitioned to obtain Γ={Γ₁, Γ₂, . . . , Γₖ}, Γⱼ=Ø and j=1, . . . , k, and a UE set [symbol] ={A₁, A₂, . . . , Aₖ} can be obtained according to Γ, where Aᵢ= {UEⱼ|yⱼ∈Γᵢ}. Optionally, the following solving steps 1 to 4 are included:

step 1: select, based on a roulette rule, centers {c₁, c₂, . . . , cₖ} of initial groups.

In step 1-1, a sample point is randomly selected from a sample set {y₁, y₂, . . . , yₙ} as a center of a first group, which is denoted as c₁;
in step 1-2, a center cᵢ=y′ E F of a next group is selected according to a probability

$$P ( {y}^{′} ) = \frac{{D}^{2} ( {y}^{′} )}{{\sum }_{y ∈ Y} {D}^{2} ( {y}^{′} )} ,$$

where D(y) represents a shortest distance between a sample point y and a selected center point closest to the ample point; and
in step 1-3: step 1-2 is repeated until centers {c₁, c₂, . . . , cₖ} of k initial groups are found.

Step 2: Select, for each sample yᵢ, a group, where yᵢ is an i^{th} row vector of F, i=1,2, . . . | [symbol] |.

In step 2-1, for each sample point yᵢ, its Euclidean distance dis(yᵢ, cⱼ)=∥yᵢ−cⱼ∥² from each center point is calculated, where i=1, . . . , n, j=1, . . . , k; and
in step 2-2, a group of the sample yᵢ is determined according to a minimum distance center μⱼ, and a sample fᵢ is partitioned to Γⱼ, Γⱼ=Γⱼ∪{yᵢ}.

Step 3: For Γⱼ ∈Γ, j=1, . . . , k, update the center of each group,

$${c}_{j} = \frac{{\sum }_{y ∈ {Γ}_{j}} y}{\vert {Γ}_{j} \vert} .$$

Step 4: Repeat steps 2 and 3 until a center point set {c₁, c₂, . . . , cₖ} no longer changes or a maximum number of iterations is reached.

When a number of sets, k, is close to an actual optimal set number, a value of SSE will decrease rapidly with an increase of k. However, when the number of sets, k, exceeds the actual optimal set number, SSE will still decrease, but a decrease velocity will become slow significantly. Therefore, an inflection point of a SSE velocity change can be found by plotting a k-SSE curve, and then, an optimal value of the number of sets, k, is determined.

Hereinafter, the process of solving an optimal grouping provided by the embodiments of the disclosure is exemplarily explained.

In a model applied in the embodiments of the disclosure, input data thereof includes: UE groups {UE₁, UE₂, . . . , UEₙ} and the number of sets, k; and output data includes: an optimal set [symbol] ={A₁, A₂, . . . , Aₖ}.

Various operations executed by the model are as follows:
operation 1: construct an adjacency matrix X, a degree matrix D and a Laplacian matrix L=D−X.

Operation 2: Normalize the Laplacian matrix,

$${L}_{sym} = {D}^{- \frac{1}{2}} {LD}^{- \frac{1}{2}} .$$

Operation 3: Calculate first k feature vectors f₁, f₂, . . . , fₖ of L_{sym}.

Operation 4: Normalize a matrix U∈ [symbol] ^{n×k} composed of these k feature vectors by rows to obtain F∈ [symbol] ^{n×k}

Operation 5: Represent an i^{th} row of a matrix F with yᵢ∈ [symbol] ^{k}, i=1, . . . , n.

Operation 6: For a sample point Y=(yᵢ)_{i=1, . . . ,n}, randomly select a point as a center c₁ of a first set.

Operation 7: Select a center cᵢ=y′∈F of a next set according to a probability

$$P ( {y}^{′} ) = \frac{{D}^{2} ( {y}^{′} )}{{\sum }_{y ∈ Y} {D}^{2} ( y )} ;$$

where D(y) identifies the shortest distance from a point y to its nearest selected center.

Operation 8: Repeat step 7 until centers {c₁, c₂, . . . , cₖ} of k initial sets are found.

Operation 9: For each data point, calculate the distance from the data point to the center of a set, and allocate it to the set to which a nearest set center belongs.

Operation 10: For each set, recalculate its set center.

Operation 11: Repeat steps 9 to 10 until the set no longer changes or a maximum number of iterations is reached.

A performance evaluation index SSE is introduced into this method, and in the above-mentioned operations, all possible UE partitions are derived according to a different set number k. In order to determine the optimal k, SSE is used, which represents the sum of squares of the distances between points in each set and a set center:

$$SSE = {\sum }_{k = 1}^{K} {\sum }_{y ∈ {C}_{k}} {\vert y - {c}_{k} \vert}^{2} .$$

Optionally, an embodiment of the disclosure provides a method 1 for determining the reserved resource information for a UE set, where when 3D resource grid planning is performed based on the above-mentioned partitioning cases, a resource grid is marked as {Tm, Fm, Lm} with 3D coordinates.

For a time domain Tm, a reservation policy based on traffic properties and delay requirements is as follows: (1) For aperiodic delay critical traffic, a resource set is reserved at interval t, and any data can be transmitted in t after being generated; and (2) for periodic delay critical traffic, a resource set is reserved at interval t within an estimated transmission range of each period.

Optionally, determining the reserved resource information (for frequency and space resources, a PMU based allocation process) of each UE set includes executing, for each UE set, operations in the following steps 1 to 2:

step 1: for each UE, determine the number of UEs performing transmission simultaneously with the UE (calculate the number of neighboring UEs that may perform transmission simultaneously with UE according to a probability).

A probability that each UE needs to transmit data on each slot is Pᵢ(t), where i is i^{th} UE, t is a t^{th} slot, t∈[0, θ]. n represents the number of all UEs within one probabilistic MU group. Firstly, an average number of other UEs performing transmission together with UEi on the t^{th} slot is calculated, and its expression is as follows:

$${I}_{a v g} ( i , t ) = {\sum }_{x = 1}^{n - 1} ( x * {P}_{i} ( t ) {\sum }_{k = 1}^{x} ( \begin{matrix}x \\ n - 1\end{matrix} ) {\prod }_{m = 1}^{x} {P}_{m ↔ a} ( t ) ) \qquad Formula 17$$

where m↔a represents that an absolute subscript of m^{th} UE in a combination is a, and P_{m↔a}(t) is a transmission probability of the m^{th} UE on slot t.

A maximum number of the other UEs performing transmission together with the UEi on the t^{th} slot is calculated, and its expression is as follows:

$$\begin{matrix}{I}_{max} ( t ) = max ( x ) \\ s . t . {P}_{i} ( t ) {\sum }_{k = 1}^{x} ( \begin{matrix}x \\ n - 1\end{matrix} ) {\prod }_{m = 1}^{x} {P}_{m ↔ a} ( t ) > 0\end{matrix} \qquad Formula 18$$

Finally, on all the slots, the number of the other UEs performing transmission together with the UEi may take a value from the above-mentioned average value and maximum value according to delay requirements of this group of UEs, as shown in formula 19 below:

$${I}_{i} ( t ) = \{ \begin{matrix}{I}_{a v g} ( i , t ) & delay critical \\ {I}_{max} ( i , t ) & ultra - delay critical\end{matrix} \qquad Formula 19$$

When I_{average}(t) or Iₘₐₓ(t)>Lₘₐₓ−1, I_{i,θ}=max{Iᵢ(t), Lₘₐₓ−1}. Lₘₐₓ is a maximum number of spatial multiplexing layers.

Step 2: Determine, for each UE, based on the number of UEs performing transmission simultaneously and the number of resources required by the UE, reserved resource information.

Based on the above-mentioned maximum number lei of interference layers, maximum inter-layer interference of the UE can be worked out. An MIMO detection algorithm used by a base station may be an MMSE algorithm, where a detection matrix W enables min|Wx−x|², and based on calculated W, inter-layer interference may be calculated. Then, under the maximum inter-layer interference, a signal and interference to noise ratio of the UE can be represented as formula 20 below:

$${SINR}_{i} = \frac{{W}_{i} S i}{N + {\sum }_{j = 1 ; j \neq i + 1}^{Ii} S j {W}_{l} H j} \qquad Formula 20$$

where N is interference and a load BOᵢ of the UE is known, and based on the foregoing SINRᵢ, the number Bᵢ of RB resource blocks required by the UE can be calculated according to formula 21 below:

$${B}_{i} = \frac{{BO}_{i}}{log ( 1 + {SINR}_{i} )} \qquad Formula 21$$

After the number of the RBs required by the UE is obtained, the RBs can be allocated to the UE by adopting a related algorithm of the following resource allocation mode. By means of the following goal-driven algorithm, resources can be allocated to the UE, and resources allocated to one probabilistic MU group are minimized.

A matrix A is defined as a UE resource allocation pattern in one probabilistic MU group, where A ∈R^{L×N}, with L representing the number of spatial multiplexing layers, and N representing the number of UEs. An array element aₗₙ of the matrix A takes a value between 0 and 1, where 1 represents that resources on an l layer are allocated to the UE n. Thereupon, the expressions for a minimum number RBₘᵢₙ of the resource blocks allocated to the probabilistic MU group are as follows:

$$\begin{matrix}R {B}_{min} = min ( max ( [ \begin{matrix}1 & 1 & 0 \\ … & … & … \\ 0 & 0 & 1\end{matrix} ] * {[ \begin{matrix}{B}_{1} & … & {B}_{N}\end{matrix} ]}^{T} ) ) \\ s . t . {\sum }_{l = 1}^{L} {b}_{l n} = 1 \\ s . t . L \leq L max\end{matrix} \qquad Formula 22$$

To solve for the minimum RBₘᵢₙ, the following algorithm is executed. Ideal RBₘᵢₙ is a mean of a total number of the resource blocks required by the UE over the number of spatial multiplexing layers, namely, ΣBᵢ/L. Therefore, our algorithm takes this mean as the initial target number of the resource blocks, namely, RBₜₐᵣ=ΣᵢBᵢ/L.

Optionally, a goal-oriented resource allocation algorithm includes the following operations 1 to 4:
operation 1: determine the initial target number RBₜₐᵣ of resource blocks, RBₜₐᵣ=ΣᵢBᵢ/L.

Operation 2: Compare the initial target with maximum UEBᵢ, if RBₜₐᵣ<max(Bᵢ), update RBₜₐᵣ to max(Bᵢ), and otherwise, proceed to operation 3.

Operation 3: Determine a UE combination or a single UE, where the number of their resource blocks is closest to but is less than the above-mentioned RBₜₐᵣ, that is: min (ΣᵢBᵢ−RBₜₐᵣ), (ΣᵢBᵢ≤RBₜₐᵣ) (when multiple UE combinations have a same number of resource blocks, a combination of UEs with a maximum probability of transmitting data simultaneously is selected for resource block allocation).

Operation 4: If L spatial multiplexing layers have been filled, but there are still UEs that have no resources allocated, updating is performed again RBₜₐᵣ=RBₜₐᵣ+1. Operations 2 and 3 are repeated until all UEs are allocated with the RBs.

Optionally, the resource allocation modes involved in operations 1 to 4 above may be used for UE data transmission. Minimum RBs allocated to the PMU are less than or equal to a final target PRB. It is noted that when operation 3 is executed, there is a need to consider the transmission probability of the UE for determination of a UE PRB combination, such that the UE is placed on a different RB when the probability of the UE performing data transmission simultaneously is relatively large.

Optionally, when the reserved resource information for each UE set is determined, an embodiment of the disclosure further provides a method 2 (including executing the following steps 1 to 3 for each UE set). In order to obtain high resource utilization, a minimum RB resource reservation mode meeting frequency domain and the space domain transmission requirements is found for the UE sets of the foregoing group, and the number of RBs is extended to improve transmission reliability.

In step 1, reserved resource information corresponding to each UE in the UE set is determined (the number of RBs requested by each UE is calculated based on a resource reservation policy).

The number of RBs requested by UEi can be calculated by formula 23 below:

$$RbNum ( i ) = \frac{DataVolume ( i )}{TBS ( SINR ( i ) )} \qquad Formula 23$$

where DataVolume (i) is a data amount of the UE i based on the reservation policy (if a delay requirement is extremely low, the data amount is equal to the maximum data amount of UE traffic; if the delay requirement is relatively low, the data amount is a small data amount, such that the UE reports a buffer size in time). SINR(i) is a signal and interference to noise ratio of the UE i, and TBS(·) is a function that calculates a transmission block size of each RB according to SINR.

In step 2, reserved resource information for the UE set is determined based on the reserved resource information corresponding to each UE (in frequency and space resource domains, RBs requested by each UE are combined, and an RB resource reservation mode is orchestrated, such that the number of minimum RBs requested by the UE is calculated).

On the principle of a minimum number of reserved RBs, excessive reservation of resources is avoided. A method for orchestrating the RB resource reservation mode includes the following operations 1 to 4:
operation 1: sort UE in descending order according to the number of requested RBs.

Operation 2: Calculate the initial target number of RBs, as shown in formula 24 below:

$$TargetRbNum = ( ceil ( Sum ( RbNum ) / L ) > Max RbNum ) ? ceil ( Sum ( RbNum ) / L ) : Max RbNum \qquad Formula 24$$

where L is set to be a maximum spatial layer, and “MaxRbNum” is the maximum number of RBs requested by UE.

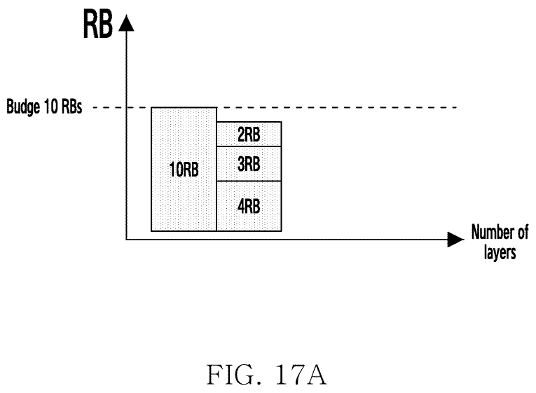

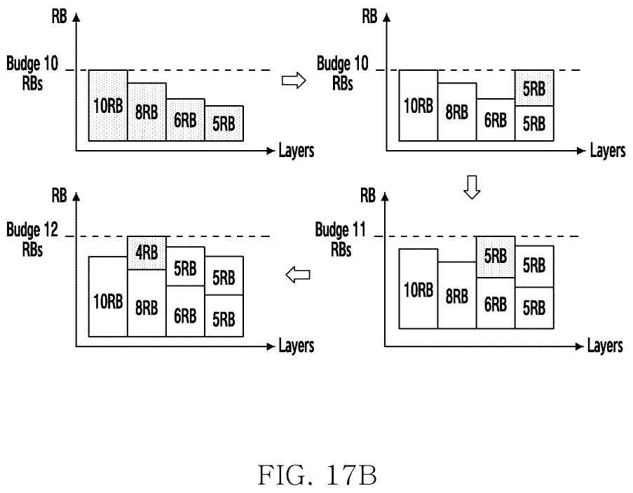

FIG. 17A is a schematic diagram of a coordinative RB resource provided according to an embodiment of the disclosure.

FIG. 17B is a schematic diagram of another coordinative RB resource provided according to an embodiment of the disclosure.

Operation 3: When the number of UEs is ≤ L, as shown in FIG. 17A, for each layer, when TotalRbNumOfLayer<=TargetRbNum, multiple UEs are combined.

Operation 4: When the number of UEs is >L, as shown in FIG. 17B, place next UE (in order) on a layer with minimum TotalRbNumOfLayer. After new UE is added to this layer, TotalRbNumOfLayer>TargetRbNum, TargetRbNum is updated to TTotalRbNumOfLayer.

In step 3, the reserved resource information for the UE set is extended based on probabilistic multiplexing information (a minimum number of the RBs of the UE set is extended based on the number of probabilistic multiplexing layers).

In order to guarantee transmission reliability, the number of the RBs will be extended based on the probabilistic multiplexing layer, and will be transmitted at a relatively low code rate.

In step 3-1, a multiplexing layer is calculated based on a transmission probability, which is marked as PMLayerNum.

In step 3-2, the number of the RBs requested by the UE is extended according to the RB resource reservation mode determined in step 2, as shown in formula 25 below:

$$R b N u m ( i ) = R b N u m ( i ) * 1 {0}^{PMLayerNum / 10} \qquad Formula 25$$

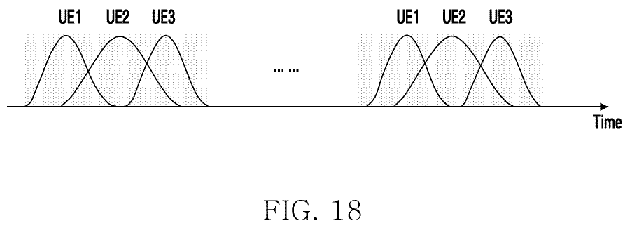

FIG. 18 shows a schematic diagram of extending the number of minimum RBs of a UE set according to an embodiment of the disclosure.

FIG. 18 shows an example where the multiplexing layer PMLayerNum=2.

The RB resource saving effects are as follows:

1) The minimum number of RBs is extended from 10 RBs (as shown in FIG. 17A) to 15 RBs, which reduces the reserved resources by 21% without probabilistic multiplexing in comparison with a total of 19 RBs originally requested.

2) The minimum number of RBs is extended from 12 RBs (as shown in FIG. 17B) to 30 RBs, which reduces the reserved resources by 30% without probabilistic multiplexing in comparison with a total of 43 RBs originally requested.

In an embodiment of the disclosure, considering the case of channel conditions and network changes in an example application, as shown in Branch 3 of FIGS. 9A and 9B, a dynamic resource grid adjustment scheme is also provided (this adjustment mechanism is configured to be implemented in a short-time-scale environment). In order to alleviate the decline of MU pairing performance caused by an instantaneous channel or network change (such as a change in the number of UEs accessing a network), the UE is exchanged between sets of a same time dimension, and a resource grid (reserved sub-resources) is adjusted based on an adjusted UE set in time domain, frequency domain and space domain dimensions, thereby achieving better spectral efficiency. Specifically, the resource grid and optimal UE groups can be applied to an adjuster, UE distribution between the groups is dynamically adjusted (an adjustment of a UE set), and the resource grid is updated (corresponding reserved sub-resources are updated to adapt to the adjustment of the UE set) to adapt to the channel conditions and the network changes.

Optionally, when the channel conditions are relatively good, but a delay cannot meet the requirements, a time domain can be adjusted without changing a frequency domain.

Specific content of dynamically adjusting the UE set and updating the reserved sub-resources in the embodiment of the disclosure will be explained below.

In an embodiment of the disclosure, in order to guarantee that the reserved resources meet delay requirements and a probabilistic multiplexing gain is not reduced, when the channel conditions change, the number of UE changes or a delay in transmitting a packet by the UEs changes, reserved frequency domain and time domain resources need to be adjusted. The adjustment may include rearranging UE sets, and reallocating the number of RBs and a time length according to different cases.

In a feasible embodiment, the method executed by the first node further includes operations S103 to S104:
operation S103: process, based on reserved resource information corresponding to the UE set, traffic of each UE in the UE set, and acquire traffic processing information, or transmit the reserved resource information to a second node and receive traffic processing information fed back by the second node processing, based on the reserved resource information, the traffic of each UE in the UE set.

Traffic of UEs corresponding to a first traffic type can be implemented in the first node, or the determined reserved resource information can be transmitted by the first node to the second node, and the traffic of the UE corresponding to the first traffic type is processed by the second node processes based on received reserved resource information.

Optionally, traffic processing information can be obtained after corresponding processing is performed on the traffic of the UE corresponding to the first traffic type. For example, after the traffic is transmitted, traffic transmission-related information can be obtained.

Operation S104: Adjust, based on the traffic processing information, UE sets, and determine reserved resource information (namely, resource grid information) of each adjusted UE set.

In an embodiment of the disclosure, considering that a radio channel condition may change in real time and the number of UEs accessing a network will change, a fine adjustment can be performed on a group of the UE sets according to real-time channel conditions and a real-time scheduling case to finely meet a UE traffic delay requirement. For example, traffic A in a UE set subS1 is re-partitioned into a UE set subS2. After the UE sets are re-partitioned, adjusted resource grid information can be determined accordingly.

Optionally, the operation of adjusting, based on the traffic processing information, the UE sets, and determining reserved resource information for each adjusted UE set in operation S104 includes operations S104a to S104d:

Operation S104a: determine, based on the traffic processing information, a UE set to be adjusted from at least one UE set.

Operation S104b: partition UEs in the UE set to be adjusted to other UE sets to obtain new candidate UE sets.

Operation S104c: determine second spectral efficiency corresponding to each new candidate UE set.

Operation S104d: determine, based on the second spectral efficiency, at least one adjusted UE set from the new candidate UE sets, and determine reserved resource information corresponding to each adjusted UE set.

Considering UEs partitioned into a same set (corresponding to corresponding traffic), there may be a possibility of MU multiplexing between different UEs due to a channel correlation. When MU multiplexing is performed between UEs in a set, the radio channel condition may change, the number of UEs accessing the network may also change, and the performance of MU multiplexing between different UEs may change, resulting in a decrease in spectral efficiency. Therefore, it is necessary to perform an inter-set adjustment on the UEs in this case and adjust resource allocation to obtain optimal spectral efficiency. In addition, when it is monitored that a delay in transmitting a data packet by the UE cannot meet the requirements, the resource allocation also needs to be adjusted.

When it is detected that the radio channel condition changes, or that there is a new UE accessing or a link is released, a decrease in spectral efficiency of a UE set k exceeds a certain threshold value Th, then the inter-set adjustment is performed on UE group of the UE set k again, and an adjusted new 3D resource grid is determined. For the UE set k, a maximum number of UEs that can be multiplexed is Lₖ, UEᵢ belongs to the UE set k, and a probability of the UEᵢ performing transmission on slot t is Pₖᵢ(t), then a simultaneous transmission probability is as shown in the formula 26 below:

$$Γ = {\prod }_{i = 0}^{n} {P}_{k i} ( t ) {\prod }_{i = n + 1}^{{L}_{k}} ( 1 - {P}_{k i} ( t ) ) \qquad Formula 26$$

where n is the number of UEs performing transmission simultaneously. The spectral efficiency of the UEᵢ is Θₖᵢ, and average spectral efficiency of the UE set k can be obtained, as shown in formula 27 below:

$${\check{Θ}}_{k} = {\int }_{t - τ}^{t + τ} ( {\sum }_{n = 1}^{{L}_{k}} ( \begin{matrix}{L}_{k} \\ n - 1\end{matrix} ) Γ {\sum }_{i = 1}^{n - 1} ( {Θ}_{k i} - ( n - 1 ) ε ) ) dt / 2 τ \qquad Formula 27$$

A UE set l overlapping with the UE set k in time domain is selected as a target adjusted UE set, and a maximum number of the UEs that can be multiplexed is Lₗ, the UEⱼ belongs to the UE set l, then average spectral efficiency of the UE set l is Θ̆ₗ. ∈ is spectral efficiency backoff.

If the UEᵢ and the UEⱼ are interchanged and adjusted to the UE sets l and k, spectra Θₗ^{′} and Θₖ^{′} of new UE sets/and k are obtained by calculation, and an objective function at this time is as shown in formula 28 below:

$$U E \{ i , j \} = argmax ( \frac{{\check{Θ}}_{k}^{′} + {\check{Θ}}_{l}^{′}}{{\check{Θ}}_{k} + {\check{Θ}}_{l}} ) UEi ∈ k , UEi ∈ l … \qquad Formula 28$$

In an embodiment of the disclosure, taking optimizing the spectral efficiencies before and after adjustment as a target, optimal group can be calculated by a mathematical method, an optimal solution of delay critical UE set partitioning is obtained, and a corresponding 3D resource grid is adjusted, thereby improving the spectral efficiency.

After each adjusted UE set is determined, reserved sub-resources can be allocated to each adjusted UE set, and a resource grid corresponding to the adjusted reserved sub-resources may refer to the example shown in FIG. 8C.

In an embodiment of the disclosure, a delay critical UE set and a corresponding reserved sub-resource thereof can be dynamically adjusted according to channel condition changes in a small time scale, thereby avoiding excessive grant-free resource reservation on the premise of guaranteeing a delay critical traffic slicing delay, and improving overall system performance.

In the disclosure, a 3D resource grid adjustment mechanism is designed to use a monitor to track a change in channel conditions, a change in the number of UEs and a delay in transmitting data packets by the UE, and to adjust resource allocation in a short time period. The 3D resource grid adjustment mechanism includes a frequency domain adjustment and a time domain adjustment in the short time period.

For the frequency domain adjustment, resources allocated to the UEs in a current set cannot meet the conditions of probabilistic MU due to the change in channel conditions or the change in the number of UEs. In this case, it is necessary to reselect a frequency domain resource for the UE. A target resource is defined as a resource similar in time dimension to a resource where the UE is located, and a target set is defined as a UE set using the target resource. Reselecting the frequency domain resource for the UE is to adjust the UE to an optimal target set. The adjustment includes the following two parts:
1) when an SINR of the UE decreases or its BLER increases, it is necessary to adjust the UE to the target set; and
2) when there are multiple target sets, when probabilistic MU is performed between the UEs and the UE in the target set, a target set with a maximum data rate gain is selected as the optimal target set for the UE.

Optionally, when the adjustment is performed, firstly, a candidate UE set is selected for each UE that does not meet probabilistic multiplexing. The candidate UE set is a UE set with a simultaneous transmission probability with the UE. Then, a target UE set with a probabilistic multiplexing gain in the candidate UE set is determined for each UE. On this basis, if all candidate UE sets of a certain UE have no gain, additional resources are reserved, and the UE will not perform multiplexing. Finally, reserved resources are re-planned for previous and target/new probabilistic multiplexing groups.

In an embodiment of the disclosure, considering that a delay in transmitting the data packets by the UE, although current resource allocation can meet the BLER of the UE, it cannot meet the demands of the UE in time domain. In this case, it is necessary to adjust time domain resources for the UE.

For the time domain adjustment, when the requirements for the UE cannot be met due to the fact that there is a deviation in a position reserved in time domain, resulting in an increase in a transmission delay, although the BLER of the UE can be met, there is a need for translation adjustment to be performed on the UE in time domain according to a delay skew, and determination of a new adjusted 3D resource grid. Optionally, a resource adjustment is performed in the embodiment of the disclosure by adopting the following way:

the time of a delay in transmitting a message by UE is defined as a difference value between the time when the UE transmits the message and the end time of a current resource of the UE in time domain. The delay is denoted as ta, and a threshold value of t_{d} is denoted as tₜᵣ.

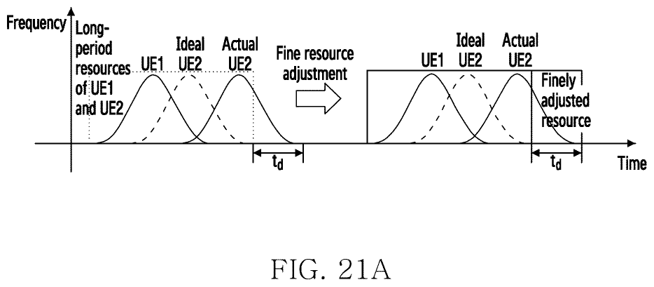

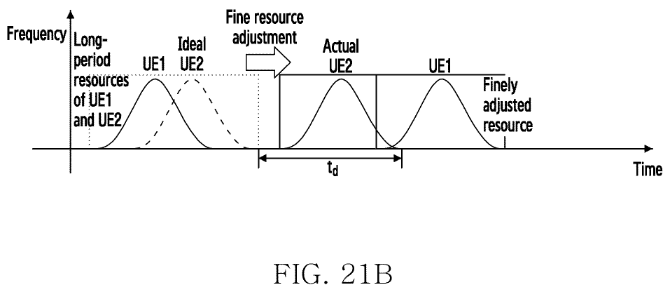

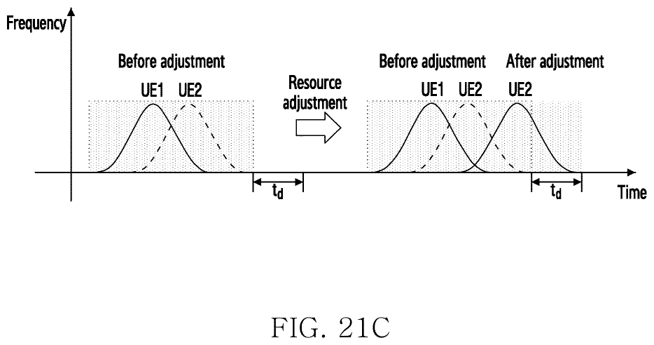

FIG. 21A is a schematic diagram of a resource adjustment provided according to an embodiment of the disclosure.

FIG. 21B is a schematic diagram of another resource adjustment provided according to an embodiment of the disclosure.

FIG. 21C is a schematic diagram of still yet another resource adjustment provided according to an embodiment of the disclosure.

Referring to FIG. 21A, 1) When t_{d}≤tₜᵣ, a time domain position where the current resource is allocated is moved backwards to include data packet transmitting time of the UE.

Referring to FIG. 21B, 2) When t_{d}>tₜᵣ, the time domain position where the resource is allocated is moved forwards to include the data packet transmitting time of the UE.

Referring to FIG. 21C, optionally, when the time domain resource is adjusted, a time domain offset t_{d} between a reserved resource edge and traffic generation time in time domain can be acquired for UE for which the delay requirement cannot meet. The time domain resource is extended to reservation time+t_{d}. After a reserved resource is extended in time domain, resource re-planning is performed on the overlapping probabilistic multiplexing groups, and if there are no overlapping probabilistic multiplexing groups, no processing is required.

In an embodiment of the disclosure, a corresponding reserved resource can be provided for uplink delay traffic in network slices. In an aspect, an MU-based slice multiplexing scheme is proposed to implement efficient resource reservation, which gives a DCRS architecture (as shown in Branch 1 of FIG. 9A). In another aspect, an MU-based resource planning (as shown in Branch 2 of FIG. 9A) and 3D resource grid adjustment (as shown in Branch 3 of FIG. 9A) schemes are proposed to implement long-term and short-term spectral efficiency maximization.

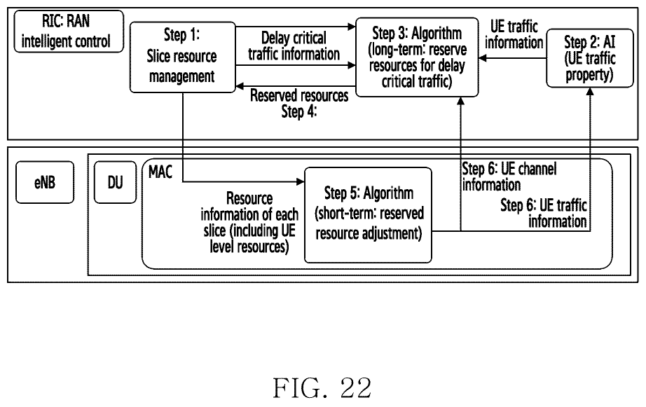

FIG. 22 is a flowchart of a method provided according to an embodiment of the disclosure.

Referring to FIG. 22, slice resource management (slicing and resource management) and a long-term resource reservation algorithm for delay critical traffic (generating reserved resources for each slice) can be implemented inside an RIC, and a short-term reserved resource adjustment algorithm (quickly adjusting the reserved resources according to real-time scheduling) can be implemented inside an MAC module of a DU of a gNB device, which can be specifically implemented by the following steps:

step 1: Partition, by a slice resource management part of the RIC, zones according to UE SLA and traffic information.

Step 2: Study, by AI of the RIC, historical features of UE traffic (traffic arrival time, period features and the like), predict new traffic features of a next long period P1, and feedback UE traffic information to an the resource reservation algorithm part of the RIC.

Step 3: Run, by the RIC, the long-term resource reservation algorithm for a delay critical bearer, and partition UEs into different UE groups according to slice and delay critical traffic type information provided by a slice management part and UE traffic features provided by the AI part of the RIC.

Step 4: Run, by the RIC, a resource reservation algorithm according to UE channel information, allocates resources for each slice within the long period P1 (such as 160 ms), and output reserved resources to the slice resource management part. The reserved resources include resources for each slice, each UE group and each UE.

Step 5: Schedule, by an MAC, the UE according to resource information (per UE) of each slice acquired from the RIC. The MAC runs a short-term algorithm to allocate the reserved resources to the UEs for which the quality requirements cannot met in real-time scheduling.

Step 6: Collect, by the MAC, channel quality information and feeds back the same to the RIC.

A grant-free resource reservation scheme proposed by embodiments of the disclosure is not limited to RAN slice scenarios, and can be applied to any network scenario.

In an embodiment of the disclosure, the number of reserved multiplexed UE can be increased, and reserved RBs can be reduced, which can effectively improve the utilization and spectral efficiency of the reserved RBs. The delay performance is almost less than the requirement of an RAN PDB, and a PMU-SM scheme can guarantee the RAN PDB of delay critical traffic.

Specifically, as shown in FIG. 4B the method executed by the second node provided by the embodiment of the disclosure includes the following operations S201 to S202:
operation S201: receive reserved resource information (reserved collaborative resource space information) corresponding to a UE group, transmitted by a first node, where the UE group includes a group determined based on traffic-related information of UE; and
operation S202: process, based on the reserved resource information, traffic of each UE in the UE group.

The second node can receive reserved resource information determined by other nodes, that is, a resource reservation policy can be determined by the other nodes. After receiving corresponding reserved resource information, the second node can perform processing on the traffic of the UE by using the reserved resource information, thereby avoiding delay scheduling and effectively meeting the low delay requirement of the traffic.

In a feasible embodiment, the operation of receiving reserved resource information corresponding to a UE group, transmitted by a first node in operation S201 includes: receiving reserved resource information corresponding to a UE set, transmitted by the first node.

The UE sets includes sets obtained partitioning, by the first node, based on resource multiplexing information, a simultaneous transmission probability and/or interference information between the UEs, the UE group. Optionally, partitioning of the UE sets may refer to an embodiment provided by the method executed by the first node in the above-mentioned embodiments, which will not be repeated here in the disclosure.

In a feasible embodiment, the operation of processing, based on the reserved resource information, traffic of each UE in the UE group in operation S202 includes steps B1 to B2:
step B1: processing, based on the reserved resource information, traffic of each UE in a UE set to obtain traffic processing information; and
step B2: feeding back the traffic processing information to a first node, and/or adjust, based on the traffic processing information, the UE set, and determine reserved resource information for each adjusted UE set.

After the second node performs, based on received reserved resource information, corresponding processing on the traffic of each UE in the UE group, the traffic processing information can be fed back to the first node, and partitioning of the UE sets is adjusted by the first node, or can be adjusted by the second node itself.

Optionally, the operation of adjusting, based on the traffic processing information, the UE set, and determining reserved resource information for each adjusted UE set in step B2 includes steps B2a to B2d:

step B2a: determining, based on the traffic processing information, a UE set to be adjusted from at least one UE set.

Step B2b: partitioning UEs in the UE set to be adjusted to other UE sets to obtain new candidate UE sets.

Step B2c: determining second spectral efficiency corresponding to each new candidate UE set.

Step B2d: determining, based on the second spectral efficiency, at least one adjusted UE set from the new candidate UE sets, and determine reserved resource information corresponding to each adjusted UE set.

Related operation instructions with respect to steps B2a to B2d may refer to related content of operations S104a to S104d, which will not be repeated here in the disclosure.

In an embodiment of the disclosure, the reserved resource information includes a set index and at least one of time domain resource information, frequency domain resource information and space domain resource information corresponding thereto, where the time domain resource information includes time domain start time and time domain end time; the frequency domain resource information includes a frequency domain start RB index and a frequency domain end RB index; and the space domain resource information includes a service index used for spatial multiplexing.

In an embodiment of the disclosure, the first node includes at least one of: a radio access network controller, a near real-time RAN intelligent controller (Near-RT RIC) of an open radio access network (ORAN) functional module, a non-near real-time RAN intelligent controller (Non-RT RIC) of a service management and orchestration (SMO) module, a distributed unit of the ORAN functional module, a Centralized Unit (CU) (or CU (control unit)) of the ORAN functional module, and a base station.

In a feasible embodiment, the second node includes at least one of: a radio access network device, a distribution unit of an ORAN functional module, and a base station.

In an embodiment of the disclosure, in an aspect of an embodiment of the disclosure, considering the problem that poor spectral efficiency is caused by reserving excessive dedicated resources due to the fact that an uplink scheduler does not know the time when the traffic is generated, an MU-SM (multi-user based slice multiplexing) scheme is proposed, where the implementation of the scheme can reduce excessive dedicated resource reservation on the premise of guaranteeing a delay, and different policies are provided for cross-slice UEs through a DCRS to perform multiplexing transmission. In another aspect, in order to maximize the spectral efficiency, an MU-based resource planning scheme is proposed to create a long-term probabilistic multiplexing condition-based 3D resource grid for the DCRS. Moreover, in order to match an instantaneous channel or network conditions and improve the spectral efficiency, a 3D resource grid adjustment mechanism is proposed, which adjusts the resource grid by re-grouping UEs in a short term. The implementation of the disclosure may achieve improvement of resource utilization and spectral efficiency on the premise of guaranteeing delay requirements.

In order to better explain the application of the embodiments of the disclosure, some possible application examples will be given below for specific explanation:

### Application Example I

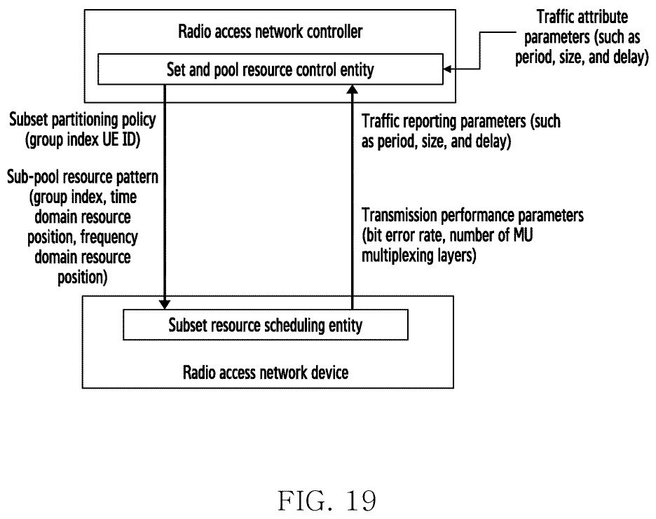

FIG. 19 is a schematic diagram of an architectural layout provided according to an embodiment of the disclosure.

Referring to FIG. 19, the first node is a radio access network controller, and the second node is a radio access network device.

A slice resource management system provided by an embodiment of the disclosure may include a linkage between the radio access network controller and the radio access network device. Optionally, a set and pool resource control entity is deployed in the radio access network controller, and a subset resource scheduling entity is deployed in the radio access network device.

The set and pool resource control entity can determine set resource reservation policies and perform partitioning of a grant-free collaborative resource space according to a traffic attribute parameter provided by a traffic provider, and traffic reporting parameters and transmission performance parameters reported by the subset resource scheduling entity. Then, a delay critical UE group is partitioned into delay critical UE sets, and a grant-free shared resource grid, namely, a grant-free shared resource sub-pool, is determined for the sets.

On this basis, the set and pool resource control entity can configure set partitioning policies and corresponding sub-pool resource grids to the subset resource scheduling entity.

After receiving the set partitioning policies and the sub-pool resource grids, the subset resource scheduling entity can apply the policies, can perform set adjustments according to real-time channel conditions and the like, and can implement scheduling for delay critical traffic in combination with a dynamic scheduling scheme and the like.

### Application Example II

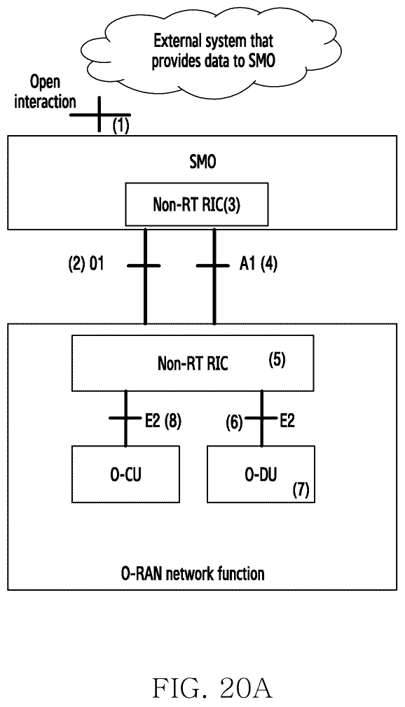

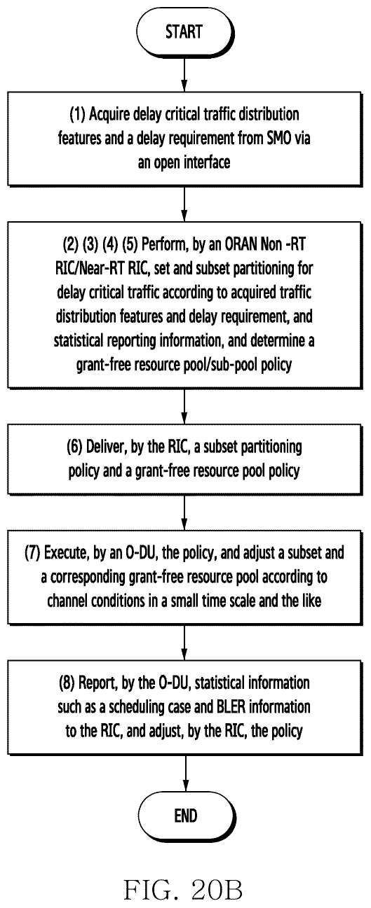

FIG. 20A is a schematic diagram of another architectural layout provided according to an embodiment of the disclosure.

FIG. 20B is a flowchart of a method corresponding to the architecture shown in FIG. 20A according to an embodiment of the disclosure.

Referring to FIG. 20A, the methods provided by embodiments of the disclosure may be implemented based on an ORAN architecture. The first node may be a Non-RT RIC, a Near-RT RIC or an O-CU (as shown in Branch 1 and Branch 2 of FIG. 9A) and the second node may be an O-DU or gNB (as shown in Branch 3 of FIG. 9A). Optionally, the set and pool resource control entity can be deployed in the Non-RT RIC or Near-RT RIC, and the set resource scheduling entity is provided in the O-DU or gNB.

Under a layout of the above-mentioned architecture, as shown in FIG. 20B, the following steps can be executed:

step (1): collect, by an SMO module, traffic distribution features of delay critical traffic from an application server, including a traffic packet size and traffic period properties. The collected information may be used for determination of a delay critical UE group/set, and resource determination of a corresponding grant-free collaborative resource space (resource pool) and/or resource grid (sub-pool).

Steps (2 to 5): receives, by the SMO module, statistical information from the O-DU via an O1 interface, including information such as an uplink BO reported size and time reported by a terminal, a scheduling BLER, and a channel correlation between UEs. The Non-RT RIC, according to the distribution features of the delay critical traffic acquired from the application server, and/or the statistical reported information from the O-DU, performs delay critical traffic modeling and channel condition modeling by using AI/ML, and then performs selection of a delay critical traffic reservation policy, partitioning of the delay critical UE groups or sets, and determination of configuration of a grant-free resource sharing pool and a grant-free resource sub-pool.

Optionally, the Non-RT RIC may also transmit delay critical traffic modeling and channel condition modeling information to the Near-RT RIC via an A₁ interface. The selection of the delay critical traffic reservation policy, the partitioning of the delay critical UE groups or sets, and the determination of the configuration of the grant-free resource sharing pool or the grant-free resource sub-pool are performed by the Near-RT RIC.

Step (6): Partition, by the Non-RT RIC or the Near-RT RIC, the delay critical UE groups or sets via an E2 interface, and transmit the configuration of the grant-free resource sharing pool or the grant-free resource sub-pool to the O-DU.

A delay critical UE set partitioning policy includes a set index and a corresponding UE ID thereof. The configuration of the grant-free resource sharing sub-pool may include a set index and a time domain resource, a frequency domain resource and a space domain resource corresponding thereto, where the time domain resource refers to time domain start and end time, and the frequency domain resource refers to a frequency domain start RB index, a frequency domain end RB index, and the space domain resource refers to a traffic index that can be used for spatial multiplexing.

Step (7): Execute, by the O-DU, transmission of the delay critical traffic by applying a policy, and adjust sub-pool resource configuration in a small time scale according to a real-time channel condition and the like.

Step (8): Report, by the O-DU, the statistical information to the SMO via an O1 interface, or report the statistical information to the Near-RT RIC via the E2 interface for subsequent selection of the delay critical traffic reservation policy, partitioning of the delay critical UE groups or sets, and determination of the configuration of the grant-free resource sharing pool or sub-pool.

### Application Example III

The method provided by the embodiments of the disclosure can be implemented by a base station, namely, when it is determined that gNB processing capacity is sufficient, the set and pool resource control entity and the sub-pool resource scheduling entity can be together provided in gNB. At this time, the first node can be understood as the set and pool resource control entity, and the second node can be understood as the sub-pool resource scheduling entity. That is, when the slice management method provided by the embodiments of the disclosure is implemented by the base station, the first node and the second node may be modules inside the base station.

In an embodiment of the disclosure, the most complicated part is a PMU based UE allocation algorithm and its computation complexity is O(k²×m×n), which involves the following three aspects:

(1) k is a maximum number of iterations to find optimal UE allocation.

$$W = {D}^{- \frac{1}{2}} L {D}^{- \frac{1}{2}}$$

is set. Maximum k is equal to the number of feature values of a matrix W. A maximum number of feature values of the matrix W is n, namely, the number of UEs in a CRS. When k is very large, in order to reduce the computational complexity, the range of k can be narrowed by the following operations:
arranging feature values in descending order;
calculating gaps of adjacent feature values; and
determining k according to a maximum gap of the feature values.

Based on this method, it can be achieved that the sum of data transmission rates of UE groups is close to an optimal UE group, and the number of its iterations is 1.

(2) n is the number of UEs in one CRS. When n is very large, multiple UEs can be firstly partitioned into several groups by determining a co-transmission probability. Therefore, an n-dimensional UE set is partitioned into several smaller-dimensional sets.

(3) m is a small number of CRSs, depending on the number of resource reservation policies.

In an embodiment of the disclosure, on the basis of transmission requirements, a PMU-SM (Probabilistic Multi-User based Slice Multiplexing) solution is proposed, as shown in FIG. 9C, to reserve UE-oriented resources. The proposed solution solves the problems of excessive resource reservation and low spectral efficiency, and guarantees a low delay of traffic. Specifically, the following effects can be achieved:

(1) Construction of a differentiated collaborative resource space (DCRS) is proposed. Based on various traffic-related feature classification, a collaborative resource space (CRS) with a particular resource reservation policy is constructed. Reserved resources are co-allocated to slices within a same CRS. Regarding the construction of the DCRS, traffic with similar transmission requirements is classified into one CRS to minimize the size of the reserved resources.

(2) A resource planning scheme based on PMU (Probabilistic multi-user), multi-UE multiplexing can be used for long-term optimization. By clustering UEs with a traffic similarity and a channel correlation in one CRS, different UE sets are grouped, and a 3D resource grid is generated for collaborative resources by a PMU method. High spectral efficiency is obtained by PMU and an optimal grouping objective function. After verification, a resource allocation reduction of 10.73% to 72.83% and a spectral efficiency improvement of 18.6% to 145.61% are achieved with different delay requirements in the proposed solution.

(3) The 3D resource grid adjustment mechanism can be used for short-term optimization. In order to track changes in the number of instantaneous channels or UEs, in this mechanism, UEs are exchanged between target UE sets with similar traffic generation time, and the resource grid is adjusted for a changed UE set to achieve better spectral efficiency.

The embodiments of the disclosure further comprise an electronic device comprising a processor and, optionally, a transceiver and/or memory coupled to the processor configured to perform the steps of the method provided in any of the optional embodiments of the disclosure.

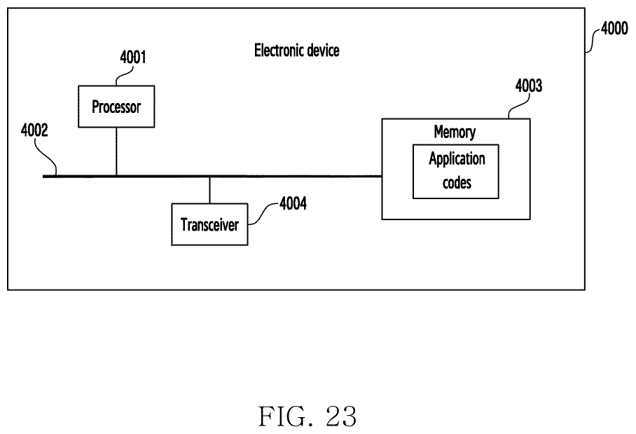

FIG. 23 shows a schematic structure diagram of an electronic device to which according to an embodiment of the disclosure is applied. Referring to FIG. 23, the electronic device 4000 shown in FIG. 23 may include a processor 4001 and memory 4003. The processor 4001 is connected with the memory 4003, for example, through the bus 4002. Optionally, the electronic device 4000 may further include a transceiver 4004 which may be used for data interaction between the electronic device and other electronic devices, such as data transmission and/or data reception and so on. It should be noted that, in practical applications, the transceiver 4004 is not limited to one, and the structure of the electronic device 4000 does not constitute a limitation to the embodiments of the disclosure. Optionally, the electronic device may be a first network node, a second network node or a third network node.

The processor 4001 may be a central processing unit (CPU), a general-purpose processor, a digital signal processor (DSP), an application-specific integrated circuit (ASIC), a field programmable gate array (FPGA) or other programmable logic devices, transistor logic devices, hardware components, or any combination thereof. It may implement or execute the various logical blocks, modules and circuits described in connection with this disclosure. The processor 4001 may also be a combination for realizing computing functions, such as a combination including one or more microprocessors, a combination of a DSP and a microprocessor, and so on. The processor 4001 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The bus 4002 may include a path to transfer information between the components described above. The bus 4002 may be a peripheral component interconnect (PCI) bus or an extended industry standard architecture (EISA) bus and so on. The bus 4002 may be divided into an address bus, a data bus, a control bus, and so on. For ease of presentation, only one thick line is used to denote the bus as shown in FIG. 23, but it does not mean that there is only one bus or one type of bus.

The memory 4003 may be a read only memory (ROM) or other types of static storage devices that may store static information and instructions, a random access memory (RAM) or other types of dynamic storage devices that may store information and instructions, it may also be an electrically erasable and programmable read only memory (EEPROM), a compact disc read only memory (CD-ROM) or other optical disk storages, optical disk storages (including a compressed compact disc, a laser disc, a compact disc, a digital versatile disc, a blu-ray disc, etc.), a magnetic disk storage media, another magnetic storage devices, or any other medium capable of carrying or storing computer programs and capable of being read by a computer, without limitation therein.

The memory 4003 is configured to store computer programs for executing the embodiments of the disclosure, and the execution is controlled by the processor 4001. The processor 4001 is configured to execute the computer programs stored in the memory 4003 to implement the steps shown in the foregoing method embodiments.

An embodiment of the disclosure provides a computer readable storage medium having computer programs stored thereon that, when executed by a processor, can implement the steps and corresponding contents in the above method embodiments.

An embodiment of the disclosure further provides a computer program product, comprising computer programs that, when executed by a processor, can implement the steps and corresponding contents in the above method embodiments.

According to embodiments, a method performed by a first node in a wireless communication system, may comprise acquiring traffic-related information of user equipment (UE), the traffic-related information of the UE comprising traffic properties and a channel correlation. The method may comprise determining, based on the traffic-related information, at least one UE group. The method may comprise determining, for each of the at least one UE group, corresponding reserved resource information. The method may comprise transmitting, to a second node, the reserved resource information corresponding to each of the at least one UE group. Traffic of each UE in UE group of the at least one UE group may be processed based on the reserved resource information.

In an embodiment, the traffic-related information may comprise at least one of a traffic packet size, a delay requirement, a bit error rate, or a number of multi user (MU) multiplexing layers.

In an embodiment, the determining, for each of the at least one UE group, of the corresponding reserved resource information may comprises determining, for a same UE group of different network slices, the reserved resource information. The determining, for each of the at least one UE group, of the corresponding reserved resource information may comprises determining, for a same UE group of a same network slice, the reserved resource information.

In an embodiment, the determining, based on the traffic-related information, of the at least one UE group may comprise partitioning, based on the traffic-related information, UEs corresponding to a first traffic type into the at least one UE group.

In an embodiment, the first traffic type may comprise a traffic type for which a delay requirement for traffic is not greater than a preset first delay threshold value.

In an embodiment, the UE group may comprise at least one of a first UE group for which a delay requirement for traffic is not greater than a preset second delay threshold value and the traffic is periodic traffic; a second UE group for which a delay requirement for traffic is not greater than the preset second delay threshold value and the traffic is aperiodic traffic; a third UE group for which a delay requirement for traffic is greater than the preset second delay threshold value and the traffic is the periodic traffic; or a fourth UE group for which a delay requirement for traffic is greater than the preset second delay threshold value and the traffic is the aperiodic traffic.

In an embodiment, the determining, for each of the at least one UE group, of the corresponding reserved resource information may comprise at least one of for the first UE group and/or the second UE group, determining, based on resource information required for performing traffic data transmission, the reserved resource information; or for the third UE group and/or the fourth UE group, determining, based on resource information required for resource scheduling, the reserved resource information.

In an embodiment, the resource information required for resource scheduling may comprise resource information corresponding to a scheduling request (SR) and/or a buffer status report (BSR).

In an embodiment, the determining, for each of the at least one UE group, of the corresponding reserved resource information may comprise at least one of for the periodic traffic included in the first UE group and/or the third UE group, determining, based on a traffic transmission period, a first period, determining, based on the delay requirement for traffic, a second period, and determining, based on each of the first period and the second period, the reserved resource information; or determining, based on the delay requirements for the second UE group and/or the fourth UE group, a third period, and determining, based on the third period, the reserved resource information.

In an embodiment, the determining, for each of the at least one UE group, of the corresponding reserved resource information may comprise determining, based on a level of multiplexing in time domain, a level of multiplexing in frequency domain and/or a level of multiplexing in space domain, at least one UE set corresponding to the UE group, and determining the reserved resource information for each of the at least one UE set to process, based on the reserved resource information, traffic of each UE in a corresponding UE set; or determining, based on a simultaneous transmission probability and/or interference information between the UEs, at least one UE set corresponding to the UE group, and determining the reserved resource information for each the at least one UE set to process, based on the reserved resource information, traffic of each UE in a corresponding UE set.

In an embodiment, the determining, based on the level of multiplexing in the time domain, of the level of multiplexing in the frequency domain and/or the level of multiplexing in the space domain, the at least one UE set corresponding to the UE group, and the determining of the reserved resource information for each of the at least one UE set may comprise determining, based on the level of multiplexing in the time domain, the level of multiplexing in the frequency domain and/or the level of multiplexing in the space domain, candidate UE sets corresponding to the UE group. The determining, based on the level of multiplexing in the time domain, of the level of multiplexing in the frequency domain and/or the level of multiplexing in the space domain, the at least one UE set corresponding to the UE group, and the determining of the reserved resource information for each of the at least one UE set may comprise determining first spectral efficiency corresponding to each candidate UE sets. The determining, based on the level of multiplexing in the time domain, of the level of multiplexing in the frequency domain and/or the level of multiplexing in the space domain, the at least one UE set corresponding to the UE group, and the determining of the reserved resource information for each of the at least one UE set may comprise determining, based on the first spectral efficiency, the at least one UE set from the candidate UE sets. The determining, based on the level of multiplexing in the time domain, of the level of multiplexing in the frequency domain and/or the level of multiplexing in the space domain, the at least one UE set corresponding to the UE group, and the determining of the reserved resource information for each of the at least one UE set may comprise determining the reserved resource information corresponding to each UE set.

In an embodiment, the first node may comprise a radio access network (RAN) intelligent controller (RIC). The second node may comprise a distributed unit.

According to embodiments, a method performed by a second node in a wireless communication system, may comprise receiving, from a first node, reserved resource information corresponding to a user equipment (UE) group. The method may comprise processing, based on the reserved resource information, traffic of each UE in the UE group. The UE group may include a group determined based on traffic-related information of UE comprising traffic properties and a channel correlation.

According to embodiments, a first node in a wireless communication system, may comprise memory, comprising one or more storage mediums, storing instructions. The first node may comprise at least one processor comprising processing circuitry. The instructions, when executed by the at least one processor individually or collectively, may cause the first node to acquire traffic-related information of user equipment (UE), the traffic-related information of the UE comprising traffic properties and a channel correlation. The instructions, when executed by the at least one processor individually or collectively, may cause the first node to determine, based on the traffic-related information, at least one UE group. The instructions, when executed by the at least one processor individually or collectively, may cause the first node to determine, for each of the at least one UE group, corresponding reserved resource information. The instructions, when executed by the at least one processor individually or collectively, may cause the first node to transmit, to a second node, the reserved resource information corresponding to each of the at least one UE group. Traffic of each UE in UE group of the at least one UE group may be processed based on the reserved resource information.

In an embodiment, the traffic-related information may comprise at least one of a traffic packet size, a delay requirement, a bit error rate, or a number of multi user (MU) multiplexing layers.

In an embodiment, the instructions, when executed by the at least one processor individually or collectively, may cause the first node, for the determining, for each of the at least one UE group, of the corresponding reserved resource information, to determine, for a same UE group of different network slices, the reserved resource information; or determine, for a same UE group of a same network slice, the reserved resource information.

In an embodiment, the instructions, when executed by the at least one processor individually or collectively, may cause the first node, for the determining, based on the traffic-related information, of the at least one UE group, to partition, based on the traffic-related information, UEs corresponding to a first traffic type into the at least one UE group.

In an embodiment, the first traffic type may comprise a traffic type for which a delay requirement for traffic is not greater than a preset first delay threshold value.

In an embodiment, the UE group may comprise at least one of a first UE group for which a delay requirement for traffic is not greater than a preset second delay threshold value and the traffic is periodic traffic; a second UE group for which a delay requirement for traffic is not greater than the preset second delay threshold value and the traffic is aperiodic traffic; a third UE group for which a delay requirement for traffic is greater than the preset second delay threshold value and the traffic is the periodic traffic; or a fourth UE group for which a delay requirement for traffic is greater than the preset second delay threshold value and the traffic is the aperiodic traffic.

According to embodiments, one or more non-transitory computer-readable storage mediums storing one or more computer programs including instructions that, when individually or collectively executed by at least one processor of a first node, may cause the first node to acquire traffic-related information of user equipment (UE), the traffic-related information of the UE comprising traffic properties and a channel correlation. The one or more non-transitory computer-readable storage mediums storing the instructions that when individually or collectively executed by the at least one processor of the first node, may cause the first node to determine, based on the traffic-related information, at least one UE group. The one or more non-transitory computer-readable storage mediums storing the instructions that when individually or collectively executed by the at least one processor of the first node, may cause the first node to determine, for each of the at least one UE group, corresponding reserved resource information. The one or more non-transitory computer-readable storage mediums storing the instructions that when individually or collectively executed by the at least one processor of the first node, may cause the first node to transmit, to a second node, the reserved resource information corresponding to each of the at least one UE group. Traffic of each UE in UE group of the at least one UE group may be processed based on the reserved resource information.

In an embodiment, the traffic-related information may comprise at least one of a traffic packet size, a delay requirement, a bit error rate, or a number of multi user (MU) multiplexing layers.

The terms “first”, “second”, “third”, “fourth”, “1”, “2”, etc. (if any) in the specification and claims of the disclosure and the accompanying drawings are used for distinguishing similar objects, rather than describing a particular order or precedence. It is to be understood that the terms used is such a way are interchangeable in the appropriate cases, such that the embodiments of the disclosure described herein may be implemented in orders other than those illustrated or described in the text.

It should be understood that, although the operation steps are indicated by arrows in the flowcharts of the embodiments of the disclosure, the implementation order of these steps is not limited to the order indicated by the arrows. Unless otherwise explicitly stated herein, in some implementation scenarios of the embodiments of the disclosure, the implementation steps in the flowcharts may be executed in other orders as required. Further, part or all of the steps in each flowchart are based on actual implementation scenarios, and may include a plurality of steps or a plurality of stages. Some or all of these steps or stages may be executed at the same moment, and each of these steps or stages may be separately executed at a different moment. In scenarios with different execution moments, the execution order of these steps or stages may be flexibly configured according to requirements, which is not limited in embodiments of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

No claim element is to be construed under the provisions of 35 U.S.C. § 112, sixth paragraph, unless the element is expressly recited using the phrase “means for” or “means”.

What is claimed is:

1. A method performed by a first node in a wireless communication system, the method comprising:
acquiring traffic-related information of user equipment (UE), the traffic-related information of the UE comprising traffic properties and a channel correlation;
determining, based on the traffic-related information, at least one UE group;
determining, for each of the at least one UE group, corresponding reserved resource information; and
transmitting, to a second node, the reserved resource information corresponding to each of the at least one UE group,
wherein traffic of each UE in UE group of the at least one UE group is processed based on the reserved resource information.

2. The method of claim 1, wherein the traffic-related information comprises at least one of a traffic packet size, a delay requirement, a bit error rate, or a number of multi user (MU) multiplexing layers.

3. The method of claim 1, wherein the determining, for each of the at least one UE group, of the corresponding reserved resource information comprises:
determining, for a same UE group of different network slices, the reserved resource information; or
determining, for a same UE group of a same network slice, the reserved resource information.

4. The method of claim 3, wherein the determining, based on the traffic-related information, of the at least one UE group comprises:
partitioning, based on the traffic-related information, UEs corresponding to a first traffic type into the at least one UE group.

5. The method of claim 4, wherein the first traffic type comprises:
a traffic type for which a delay requirement for traffic is not greater than a preset first delay threshold value.

6. The method of claim 1, wherein the UE group comprises at least one of:
a first UE group for which a delay requirement for traffic is not greater than a preset second delay threshold value and the traffic is periodic traffic;
a second UE group for which a delay requirement for traffic is not greater than the preset second delay threshold value and the traffic is aperiodic traffic;
a third UE group for which a delay requirement for traffic is greater than the preset second delay threshold value and the traffic is the periodic traffic; or
a fourth UE group for which a delay requirement for traffic is greater than the preset second delay threshold value and the traffic is the aperiodic traffic.

7. The method of claim 6, wherein the determining, for each of the at least one UE group, of the corresponding reserved resource information comprises at least one of:
for the first UE group and/or the second UE group, determining, based on resource information required for performing traffic data transmission, the reserved resource information; or
for the third UE group and/or the fourth UE group, determining, based on resource information required for resource scheduling, the reserved resource information.

8. The method of claim 7, wherein the resource information required for resource scheduling comprises resource information corresponding to a scheduling request (SR) and/or a buffer status report (BSR).

9. The method of claim 6, wherein the determining, for each of the at least one UE group, of the corresponding reserved resource information comprises at least one of:
for the periodic traffic included in the first UE group and/or the third UE group, determining, based on a traffic transmission period, a first period, determining, based on the delay requirement for traffic, a second period, and determining, based on each of the first period and the second period, the reserved resource information; or
determining, based on the delay requirements for the second UE group and/or the fourth UE group, a third period, and determining, based on the third period, the reserved resource information.

10. The method of claim 1, wherein the determining, for each of the at least one UE group, of the corresponding reserved resource information comprises:
determining, based on a level of multiplexing in time domain, a level of multiplexing in frequency domain and/or a level of multiplexing in space domain, at least one UE set corresponding to the UE group, and determining the reserved resource information for each of the at least one UE set to process, based on the reserved resource information, traffic of each UE in a corresponding UE set; or
determining, based on a simultaneous transmission probability and/or interference information between the UEs, at least one UE set corresponding to the UE group, and determining the reserved resource information for each the at least one UE set to process, based on the reserved resource information, traffic of each UE in a corresponding UE set.

11. The method of claim 10, wherein the determining, based on the level of multiplexing in the time domain, of the level of multiplexing in the frequency domain and/or the level of multiplexing in the space domain, the at least one UE set corresponding to the UE group, and the determining of the reserved resource information for each of the at least one UE set comprise:
determining, based on the level of multiplexing in the time domain, the level of multiplexing in the frequency domain and/or the level of multiplexing in the space domain, candidate UE sets corresponding to the UE group;
determining first spectral efficiency corresponding to each candidate UE sets;
determining, based on the first spectral efficiency, the at least one UE set from the candidate UE sets; and
determining the reserved resource information corresponding to each UE set.

12. The method of claim 1,
wherein the first node comprises a radio access network (RAN) intelligent controller (RIC), and
wherein the second node comprises a distributed unit.

13. A first node in a wireless communication system, the first node comprising:
memory, comprising one or more storage mediums, storing instructions; and
at least one processor comprising processing circuitry,
wherein the instructions, when executed by the at least one processor individually or collectively, cause the first node to:
acquire traffic-related information of user equipment (UE), the traffic-related information of the UE comprising traffic properties and a channel correlation,
determine, based on the traffic-related information, at least one UE group,
determine, for each of the at least one UE group, corresponding reserved resource information, and
transmit, to a second node, the reserved resource information corresponding to each of the at least one UE group, and
wherein traffic of each UE in UE group of the at least one UE group is processed based on the reserved resource information.

14. The first node of claim 13, wherein the traffic-related information comprises at least one of a traffic packet size, a delay requirement, a bit error rate, or a number of multi user (MU) multiplexing layers.

15. The first node of claim 13, wherein the instructions, when executed by the at least one processor individually or collectively, cause the first node, for the determining, for each of the at least one UE group, of the corresponding reserved resource information, to:
determine, for a same UE group of different network slices, the reserved resource information; or
determine, for a same UE group of a same network slice, the reserved resource information.

16. The first node of claim 15, wherein the instructions, when executed by the at least one processor individually or collectively, cause the first node, for the determining, based on the traffic-related information, of the at least one UE group, to:
partition, based on the traffic-related information, UEs corresponding to a first traffic type into the at least one UE group.

17. The first node of claim 16, wherein the first traffic type comprises:
a traffic type for which a delay requirement for traffic is not greater than a preset first delay threshold value.

18. The first node of claim 13, wherein the UE group comprises at least one of:
a first UE group for which a delay requirement for traffic is not greater than a preset second delay threshold value and the traffic is periodic traffic;
a second UE group for which a delay requirement for traffic is not greater than the preset second delay threshold value and the traffic is aperiodic traffic;
a third UE group for which a delay requirement for traffic is greater than the preset second delay threshold value and the traffic is the periodic traffic; or
a fourth UE group for which a delay requirement for traffic is greater than the preset second delay threshold value and the traffic is the aperiodic traffic.

19. One or more non-transitory computer-readable storage mediums storing one or more computer programs including instructions that, when individually or collectively executed by at least one processor of a first node, cause the first node to:
acquire traffic-related information of user equipment (UE), the traffic-related information of the UE comprising traffic properties and a channel correlation;
determine, based on the traffic-related information, at least one UE group;
determine, for each of the at least one UE group, corresponding reserved resource information; and
transmit, to a second node, the reserved resource information corresponding to each of the at least one UE group,
wherein traffic of each UE in UE group of the at least one UE group is processed based on the reserved resource information.

20. The one or more non-transitory computer-readable storage mediums of claim 19, wherein the traffic-related information comprises at least one of a traffic packet size, a delay requirement, a bit error rate, or a number of multi user (MU) multiplexing layers.
